(19) United States
(12) Patent Application Publication
(10) Pub. No.: US 2026/0239380 A1
(43) Pub. Date: Aug. 13, 2026

(54) CHANNEL OCCUPANCY TIME SHARING AND RESUMING BASED ON PHYSICAL SIDELINK FEEDBACK CHANNELS IN SIDELINK-UNLICENSED WIDEBAND

(71) Applicant: QUALCOMM Incorporated, San Diego, CA (US)

(72) Inventors: Luanxia Yang, Beijing (CN); Jing Sun, San Diego, CA (US); Changlong Xu, Beijing (CN); Chih-Hao Liu, San Diego, CA (US); Giovanni Chisci, San Diego, CA (US); Xiaoxia Zhang, San Diego, CA (US); Shaozhen Guo, Beijing (CN); Siyi Chen, Beijing (CN); Hao Xu, Beijing (CN)

(21) Appl. No.: 19/151,934

(22) PCT Filed: Mar. 31, 2023
(86) PCT No.: PCT/CN2023/085499

§ 371 Date: Jul. 29, 2025

(51) Int. Cl. H04W 72/25; H04W 74/08

(52) U.S. Cl. CPC H04W 72/25; H04W 74/0866

(57) ABSTRACT

This disclosure provides systems, methods, and devices for wireless communication that support channel occupancy time (COT) sharing and resuming based on physical sidelink feedback channels (PSFCHs) in sidelink-unlicensed (SL-U) wideband operations. In a first aspect, a method of wireless communication includes a COT-initiating user equipment (UE) establishing a wideband COT associated with multiple resource block (RB) sets. The COT-initiating UE transmits a COT structure information (COT-SI) including a first indication enabling COT sharing with neighboring UEs and a second indication allowing transmission of PSFCHs. The COT-initiating UE identifies the shared RBs before resuming transmission in the COT using available RBs. The responding UEs would receive the COT-SI allowing sharing and transmission of PSFCHs and will identify at least one selected PSFCH within the COT that is associated with the COT-initiating UE prior to sharing the COT with PSFCH transmissions. Other aspects and features are also claimed and described.

### TECHNICAL FIELD

Aspects of the present disclosure relate generally to wireless communication systems, and more particularly, to sidelink-unlicensed wireless communications. Some features may enable and provide improved communications, including channel occupancy time (COT) sharing and resuming based on physical sidelink feedback channels (PSFCHs) in sidelink-unlicensed (SL-U) wideband operations.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station or other network entity.

A network entity may transmit data and control information on a downlink to a UE or may receive data and control information on an uplink from the UE. On the downlink, a transmission from the network entity may encounter interference due to transmissions from neighbor network entities or from other wireless radio frequency (RF) transmitters. On the uplink, a transmission from the UE may encounter interference from uplink transmissions of other UEs communicating with the neighbor network entities or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Device-to-device communication (D2D) is a key enabler for connecting devices together to form the Internet of Things (IoT). D2D communication may be implemented using the sidelink (SL) communications. Sidelink is a core topology of the 5G system design that enables direct communication between two devices without the participation of a base station in the transmission and reception of data traffic. Sidelink communications in an unlicensed band, unlicensed sidelink (SL-U), helps to address this issue by offloading network traffic from the licensed bands, while also reducing the associated licensing costs. As SL-U communications occur over shared spectrum, each UE will first establish a channel occupancy time (COT) on an available, shared communication channel. A COT refers to the total time for which a UE and any other SL UEs sharing the COT perform transmissions on a channel. Research and development continue to address sharing of a COT by the non-COT-initiating UEs to enhance efficient access to SL-U communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method of wireless communication performed by a user equipment (UE) including establishing a channel occupancy time (COT) having a wideband operational frequency associated with a plurality of resource block (RB) sets, transmitting over an unlicensed sidelink (SL-U) channel a COT structure information (COT-SI) message that includes a first indication enabling COT sharing with one or more neighboring UEs capable of SL-U communication and a second indication allowing transmission of physical sidelink feedback channels (PSFCHs), completing a first transmission within a portion of the COT, identifying a second transmission to renew transmissions within the COT, identifying one or more shared RB sets from the plurality of RB sets, and transmitting the second transmission using one or more available RBs within the one or more shared RB sets.

In an additional aspect of the disclosure, a method of wireless communication performed by a UE including receiving a COT-SI message from a COT-initiating UE, the COT-SI including a first indication enabling COT sharing of a COT having a wideband operational frequency associated with a plurality of RB sets and a second indication allowing transmission of PSFCHs, identifying at least one selected PSFCH of a plurality of selected PSFCHs for transmissions is within an RB of the plurality of RB sets and is associated with the COT-initiating UE, and transmitting, over a SL-U channel, one or more selected PSFCHs of the plurality of selected PSFCHs in at least one RB set of the plurality of RB sets.

In an additional aspect of the disclosure, an apparatus includes at least one processor and a memory coupled to the at least one processor. The at least one processor is operable to cause a UE to establish a COT having a wideband operational frequency associated with a plurality of RB sets, to transmit over a SL-U channel a COT-SI message that includes a first indication enabling COT sharing with one or more neighboring UEs capable of SL-U communication and a second indication allowing transmission of PSFCHs, to complete a first transmission within a portion of the COT, to identify a second transmission to renew transmissions within the COT, to identify one or more shared RB sets from the plurality of RB sets, and to transmit the second transmission using one or more available RBs within the one or more shared RB sets.

In an additional aspect of the disclosure, an apparatus of a UE includes at least one processor and a memory coupled to the at least one processor. The at least one processor is operable to cause the UE to receive a COT-SI message from a COT-initiating UE, the COT-SI including a first indication enabling COT sharing of a COT having a wideband operational frequency associated with a plurality of RB sets and a second indication allowing transmission of PSFCHs, to identify at least one selected PSFCH of a plurality of selected PSFCHs for transmissions is within an RB of the plurality of RB sets and is associated with the COT-initiating UE, and to transmit, over a SL-U channel, one or more selected PSFCHs of the plurality of selected PSFCHs in at least one RB set of the plurality of RB sets.

In an additional aspect of the disclosure, an apparatus with a UE includes means for establishing a COT having a wideband operational frequency associated with a plurality of RB sets, means for transmitting over a SL-U channel a COT-SI message that includes a first indication enabling COT sharing with one or more neighboring UEs capable of SL-U communication and a second indication allowing transmission of PSFCHs, means for completing a first transmission within a portion of the COT, means for identifying a second transmission to renew transmissions within the COT, means for identifying one or more shared RB sets from the plurality of RB sets, and means for transmitting the second transmission using one or more available RBs within the one or more shared RB sets.

In an additional aspect of the disclosure, an apparatus with a UE includes means for receiving a COT-SI message from a COT-initiating UE, the COT-SI including a first indication enabling COT sharing of a COT having a wideband operational frequency associated with a plurality of RB sets and a second indication allowing transmission of PSFCHs, means for identifying at least one selected PSFCH of a plurality of selected PSFCHs for transmissions is within an RB of the plurality of RB sets and is associated with the COT-initiating UE, and means for transmitting, over a SL-U channel, one or more selected PSFCHs of the plurality of selected PSFCHs in at least one RB set of the plurality of RB sets.

In an additional aspect of the disclosure, a non-transitory computer-readable medium within a UE stores instructions that, when executed by a processor, cause the processor to perform operations. The operations include establishing a COT having a wideband operational frequency associated with a plurality of RB sets, means for transmitting over a SL-U channel a COT-SI message that includes a first indication enabling COT sharing with one or more neighboring UEs capable of SL-U communication and a second indication allowing transmission of PSFCHs, means for completing a first transmission within a portion of the COT, means for identifying a second transmission to renew transmissions within the COT, means for identifying one or more shared RB sets from the plurality of RB sets, and means for transmitting the second transmission using one or more available RBs within the one or more shared RB sets.

In an additional aspect of the disclosure, a non-transitory computer-readable medium within a UE stores instructions that, when executed by a processor, cause the processor to perform operations. The operations include receiving a COT-SI message from a COT-initiating UE, the COT-SI including a first indication enabling COT sharing of a COT having a wideband operational frequency associated with a plurality of RB sets and a second indication allowing transmission of PSFCHs, identifying at least one selected PSFCH of a plurality of selected PSFCHs for transmissions is within an RB of the plurality of RB sets and is associated with the COT-initiating UE, and transmitting, over a SL-U channel, one or more selected PSFCHs of the plurality of selected PSFCHs in at least one RB set of the plurality of RB sets.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system capable of supporting channel occupancy time (COT) sharing and resuming based on physical sidelink feedback channels (PSFCHs) in sidelink-unlicensed (SL-U) wideband operations according to one or more aspects.

FIG. 2 is a block diagram illustrating examples of a base station and a user equipment (UE) capable of supporting COT sharing and resuming based on PSFCHs in SL-U wideband operations according to one or more aspects.

FIG. 3 is a block diagram illustrating an example wireless communication system that supports COT sharing and resuming based on PSFCHs in SL-U wideband operations according to one or more aspects.

FIGS. 4A and 4B are block diagrams illustrating example processes that support COT sharing and resuming based on PSFCHs in SL-U wideband operations according to one or more aspects.

FIG. 5 is a block diagram illustrating an example SL-U network including the UE0-UE5 configured to support COT sharing and resuming based on PSFCHs in SL-U wideband operations according to one or more aspects.

FIG. 6A is a block diagram illustrating an example SL-U network including the UE0-UE5 configured to support COT sharing and resuming based on PSFCHs in SL-U wideband operations according to one or more aspects.

FIG. 6B is a block diagram illustrating an example SL-U network including the UE0-UE5 configured to support COT sharing and resuming based on PSFCHs in SL-U wideband operations according to one or more aspects.

FIG. 7 is a block diagram of an example base station that supports COT sharing and resuming based on PSFCHs in SL-U wideband operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support COT sharing and resuming based on PSFCHs in SL-U wideband operations. D2D communication allows multiple UE and IoT devices to directly communicate with one another within a 5G system. Such D2D communications may be implemented using the sidelink communications scheme, either on licensed or unlicensed spectrum. Sidelink communications in an unlicensed band, unlicensed sidelink (SL-U) communications, occur over shared spectrum. A UE that has data or control information to transmit will first establish a COT on an available, shared communication channel. A COT refers to a segment of time on the shared channel essentially reserved by a UE, during which the UE may perform communications with a low likelihood that communications from other UEs and wireless nodes, perhaps wireless node using different wireless technologies, would collide or conflict with the COT-initiating UE's communications. However, the COT-initiating UE may not have the volume of data or control information to transmit that would occupy the entire available bandwidth of the COT. Accordingly, COT-sharing is available, such that neighboring UEs may share available resources within the COT to perform their own communications. The COT-initiating UE may transmit a signal that indicates whether a particular COT can or cannot be shared. In addition, the signal may indicate whether the COT can be shared for feedback signaling, such as PSFCH.

An issue can arise when the COT-initiating UE identifies that it has control or data information available to resume transmissions in the COT after ceasing the original transmissions of the COT, but the COT is available for sharing. Because available resources within the COT may be occupied by neighboring UEs that are sharing the COT, including sharing of feedback resources, the COT-initiating UE would not be able to resume transmissions within the COT unless it can identify any resources that have been shared. If the COT-initiating UE cannot identify shared resources, then it may not know whether those resources would have colliding transmissions from a neighboring UE sharing the COT. According to the aspects described herein, a COT-initiating UE can identify shared resources within the COT by detecting feedback messages it receives from neighboring UEs in those resources. By providing the COT-initiating UE a mechanism for identifying shared resources within a COT, the COT-initiating UE may resume transmission within a COT when it identifies data or control information for resumption of transmissions. The COT-initiating UE may, thus, more efficiently use the resources that it established in the COT, instead of waiting for a new opportunity to establish a new COT.

If the COT-initiating UE did not have this mechanism to identify shared resources in the COT, it may determine not to allow sharing of the COT. Without sharing enabled, the neighboring UEs would not be able to transmit during the available resources of the COT. Additionally, the COT-initiating UE will typically not have the data and control information to occupy all available resources in the COT. Thus, by allowing the mechanism to identify shared resources, the COT resources may be used more efficiently by the neighboring UEs that identify a capability to share the COT resources with the COT-initiating UE.

Additional aspects of the disclosure further provide that the COT-initiating UE may provide an indication that neighboring UEs can share the COT when they can occupy either the entire bandwidth of the COT or a subset of resources that are required to be occupied. By requiring the sharing, neighboring UEs to share when they can occupy all of the required shared bandwidth, the likelihood would be reduced that another wireless node sharing the channel, using a different wireless technology that may not be capable of receiving the indications from the COT-initiating UE, would transmit communications that may collide with other the communications from the COT-initiating UE and neighboring UEs in the COT.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

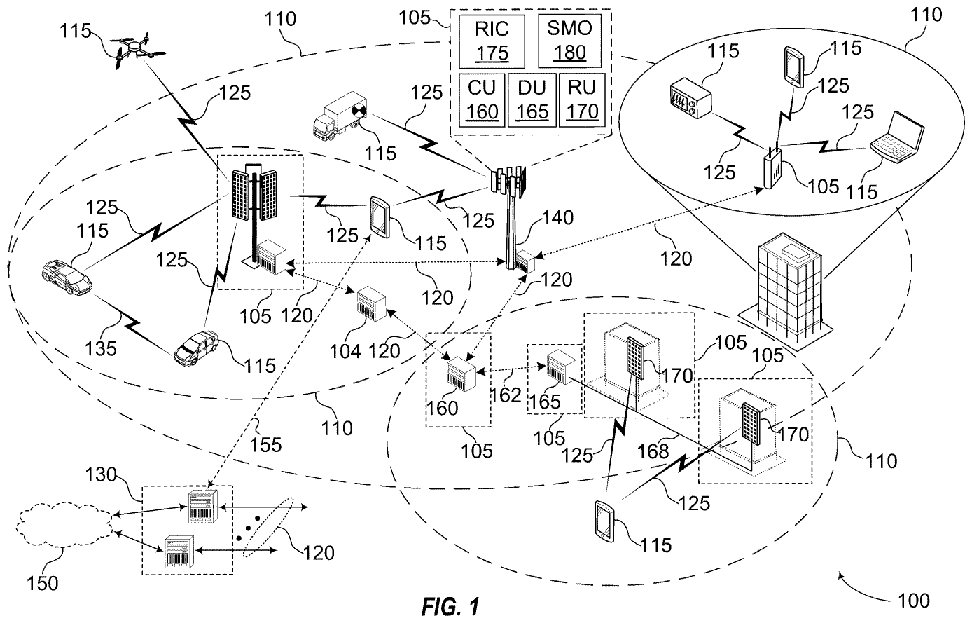

FIG. 1 illustrates an example of a wireless communications system 100 that supports RF component preferences in hybrid beamforming operations at mmWave bands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, the network entity 105 may be referred to as a network element, a mobility element, a radio access network (RAN) node, or network equipment, among other nomenclature. In some examples, the network entities 105 and the UEs 115 may wirelessly communicate via one or more communication links 125 (e.g., a radio frequency (RF) access link).

The UEs 115 may be dispersed throughout the coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be the network entity 105 (e.g., any network entity described herein), the UE 115 (e.g., any UE described herein), a network controller, an apparatus, a device, a computing system, one or more components, or another suitable processing entity configured to perform any of the techniques described herein. For example, a node may be the UE 115. As another example, a node may be the network entity 105.

In some examples, the network entities 105 may communicate with the core network 130, or with one another, or both. For example, the network entities 105 may communicate with the core network 130 via one or more backhaul communication links 120 (e.g., in accordance with an S1, N2, N3, or other interface protocol). In some examples, the network entities 105 may communicate with one another over the backhaul communication link 120 (e.g., in accordance with an X2, Xn, or other interface protocol) either directly (e.g., directly between the network entities 105) or indirectly (e.g., via the core network 130). In some examples, the network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, the midhaul communication links 162, or the fronthaul communication links 168 may be or include one or more wired links (e.g., an electrical link, an optical fiber link), one or more wireless links (e.g., a radio link, a wireless optical link), among other examples or various combinations thereof. The UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a transmission-reception point (TRP), a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, the network entity 105 (e.g., the base station 140) may be implemented in an aggregated (e.g., monolithic, standalone) base station architecture, which may be configured to utilize a protocol stack that is physically or logically integrated within a single network entity 105 (e.g., a single RAN node, such as the base station 140).

In some examples, the network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, the network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. The RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The UE 115 may include or may be referred to as a mobile device, a wireless device, a remote device, a handheld device, or a subscriber device, or some other suitable terminology, where the “device” may also be referred to as a unit, a station, a terminal, or a client, among other examples. The UE 115 may also include or may be referred to as a personal electronic device such as a cellular phone, a personal digital assistant (PDA), a tablet computer, a laptop computer, or a personal computer. In some examples, the UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, a satellite radio, a global positioning system (GPS) device, a global navigation satellite system (GNSS) device, a logistics controller, an unmanned aerial vehicle (UAV), a drone, a smart energy or security device, a solar panel or solar array, etc. among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125.

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific one of the UEs 115.

In some examples, the UE 115 may be able to communicate directly with other of the UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of the network entity 105 (e.g., the base station 140, the RU 170), which may support aspects of such D2D communications being configured by or scheduled by the network entity 105. In some examples, one or more UEs 115 in such a group may be outside of the coverage area 110 of the network entity 105 or may be otherwise unable to or not configured to receive transmissions from the network entity 105. In some examples, groups of the UEs 115 communicating via D2D communications may support a one-to-many (1:M) system in which each UE 115 transmits to each of the other ones of the UEs 115 in the group. In some examples, the network entity 105 may facilitate the scheduling of resources for D2D communications. In some other examples, D2D communications may be carried out between the UEs 115 without the involvement of the network entity 105.

In some systems, the D2D communication link 135 may be an example of a communication channel, such as a sidelink communication channel, between vehicles (e.g., the UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., the network entities 105, the base stations 140, the RUs 170) using vehicle-to-network (V2N) communications, or with both.

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between the UE 115 and the network entity 105 or the core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., the communication link 125, the D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

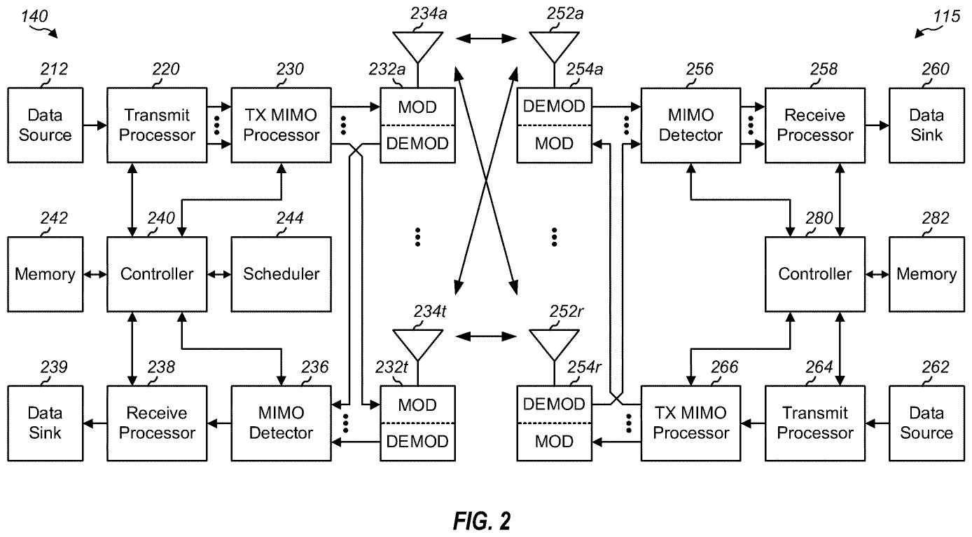

FIG. 2 is a block diagram illustrating examples of the base station 140 and the UE 115 according to one or more aspects. The base station 140 and the UE 115 may be any of the network entities and base stations and one of the UEs in FIG. 1. For a restricted association scenario (as mentioned above), the network entity 105 may be small cell base station, and the UE 115 may be the UE 115 operating in a service area of the small cell base station, which in order to access the small cell base station, would be included in a list of accessible UEs for the small cell base station. The base station 140 may also be a base station of some other type. As shown in FIG. 2, a network entity 105, such as the base station 140 may be equipped with the antennas 234a through 234t, and the UE 115 may be equipped with the antennas 252a through 252r for facilitating wireless communications.

At the base station 140, the transmit processor 220 may receive data from the data source 212 and control information from the controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, the transmit processor 220 may process (e.g., encode and symbol map) the data and control information to obtain data symbols and control symbols, respectively. The transmit processor 220 may also generate reference symbols, e.g., for the primary synchronization signal (PSS) and secondary synchronization signal (SSS), and cell-specific reference signal. The transmit (TX) MIMO processor 230 may perform spatial processing (e.g., precoding) on the data symbols, the control symbols, or the reference symbols, if applicable, and may provide output symbol streams to the modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from the modulators 232a through 232t may be transmitted via the antennas 234a through 234t, respectively.

At the UE 115, the antennas 252a through 252r may receive the downlink signals from the base station 140 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. The MIMO detector 256 may obtain received symbols from the demodulators 254a through 254r, perform MIMO detection on the received symbols if applicable, and provide detected symbols. The receive processor 258 may process (e.g., demodulate, deinterleave, and decode) the detected symbols, provide decoded data for the UE 115 to the data sink 260, and provide decoded control information to the controller 280, such as a processor.

On the uplink, at the UE 115, the transmit processor 264 may receive and process data (e.g., for a physical uplink shared channel (PUSCH)) from the data source 262 and control information (e.g., for a physical uplink control channel (PUCCH)) from the controller 280. Additionally, the transmit processor 264 may also generate reference symbols for a reference signal. The symbols from the transmit processor 264 may be precoded by the TX MIMO processor 266 if applicable, further processed by the modulators 254a through 254r (e.g., for SC-FDM, etc.), and transmitted to network entity 105. At the network entity 105, the uplink signals from the UE 115 may be received by the antennas 234, processed by the demodulators 232, detected by the MIMO detector 236 if applicable, and further processed by the receive processor 238 to obtain decoded data and control information sent by the UE 115. The receive processor 238 may provide the decoded data to the data sink 239 and the decoded control information to the controller 240.

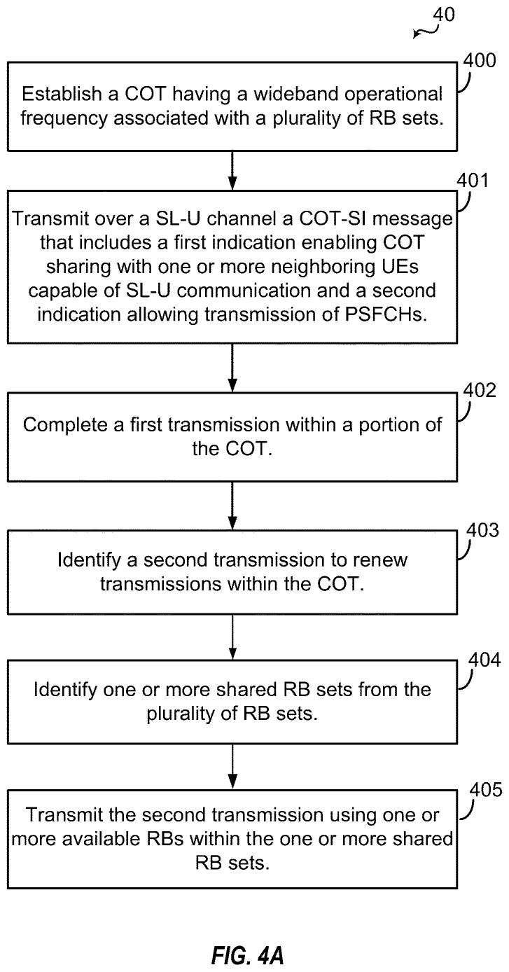

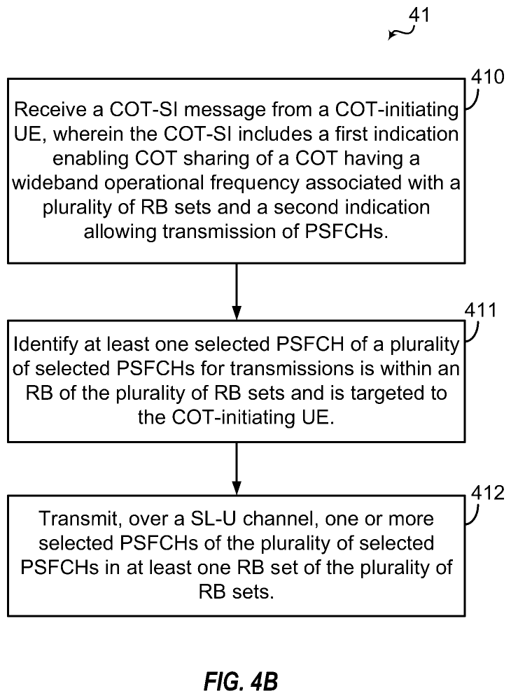

The controllers 240 and 280 may direct the operation at the base station 140 and the UE 115, respectively. The controller 240 or other processors and modules at the base station 140 or the controller 280 or other processors and modules at the UE 115 may perform or direct the execution of various processes for the techniques described herein, such as to perform or direct the execution illustrated in FIGS. 4A and 4B, or other processes for the techniques described herein. The memories 242 and 282 may store data and program codes for the base station 140 and the UE 115, respectively. The scheduler 244 may schedule UEs for data transmission on the downlink or the uplink.

In some cases, the UE 115 and the base station 140 may operate in a shared radio frequency spectrum band, which may include licensed or unlicensed (e.g., contention-based) frequency spectrum. In an unlicensed frequency portion of the shared radio frequency spectrum band, the UEs 115 or base station 140 may traditionally perform a medium-sensing procedure to contend for access to the frequency spectrum. For example, the UE 115 or the base station 140 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. A CCA also may include detection of specific sequences that indicate use of the channel.

In general, four categories of LBT procedure have been suggested for sensing a shared channel for signals that may indicate the channel is already occupied. In a first category (CAT 1 LBT), no LBT or CCA is applied to detect occupancy of the shared channel. A second category (CAT 2 LBT), which may also be referred to as an abbreviated LBT, a single-shot LBT, a 16-μs, or a 25-μs LBT, provides for the node to perform a CCA to detect energy above a predetermined threshold or detect a message or preamble occupying the shared channel. The CAT 2 LBT performs the CCA without using a random back-off operation, which results in its abbreviated length, relative to the next categories.

A third category (CAT 3 LBT) performs CCA to detect energy or messages on a shared channel, but also uses a random back-off and fixed contention window. Therefore, when the node initiates the CAT 3 LBT, it performs a first CCA to detect occupancy of the shared channel. If the shared channel is idle for the duration of the first CCA, the node may proceed to transmit. However, if the first CCA detects a signal occupying the shared channel, the node selects a random back-off based on the fixed contention window size and performs an extended CCA. If the shared channel is detected to be idle during the extended CCA and the random number has been decremented to 0, then the node may begin transmission on the shared channel. Otherwise, the node decrements the random number and performs another extended CCA. The node would continue performing extended CCA until the random number reaches 0. If the random number reaches 0 without any of the extended CCAs detecting channel occupancy, the node may then transmit on the shared channel. If at any of the extended CCA, the node detects channel occupancy, the node may re-select a new random back-off based on the fixed contention window size to begin the countdown again.

A fourth category (CAT 4 LBT), which may also be referred to as a full LBT procedure, performs the CCA with energy or message detection using a random back-off and variable contention window size. The sequence of CCA detection proceeds similarly to the process of the CAT 3 LBT, except that the contention window size is variable for the CAT 4 LBT procedure.

Sensing for shared channel access may also be categorized into either full-blown or abbreviated types of LBT procedures. For example, a full LBT procedure, such as a CAT 3 or CAT 4 LBT procedure, including extended channel clearance assessment (ECCA) over a non-trivial number of 9-μs slots, may also be referred to as a “Type 1 LBT.” An abbreviated LBT procedure, such as a CAT 2 LBT procedure, which may include a one-shot CCA for 16-μs or 25-μs, may also be referred to as a “Type 2 LBT.”

A growing issue with IoT networks is the increasing number of IoT devices congesting the spectral resources of the cellular bands. Sidelink communications in an unlicensed band, SL-U, helps to address this issue by offloading network traffic from the licensed bands, while also reducing the associated licensing costs. Sidelink-capable IoT devices and UEs may use a direct RF communication interface, such as PC5, to communicate with other IoT devices and UEs, whether via licensed or unlicensed spectrum.

As SL-U communications occur over shared spectrum, each UE will first establish a COT on an available, shared communication channel. A COT refers to the total time for which a UE and any other SL UEs sharing the COT perform transmissions on a channel after the COT-initiating UE performs the corresponding channel access procedures, such as the CCA and LBT procedures described above. For aspects associated with the present disclosure, an issue may arise when the COT-initiating UE, operating with wideband SL-U communications, has ceased transmissions, allowing the other SL UEs to share the COT, wants to resume transmission in the SL-U wideband spectrum. If COT-sharing is allowed in this scenario, the COT-initiating UE should identify which resource block (RB) sets can be occupied by its resumed transmissions, and, if not allowed, how does the COT-initiating UE ensure that the entire wideband spectrum of the SL-U communications will be occupied.

According to various aspects described herein, the COT-initiating UE may identify the shared RB sets of the multiple RB sets making up the wideband SL-U COT by detecting physical sidelink feedback channels (PSFCHs) associated with it from other COT-sharing UEs. These COT-sharing UEs transmit the PSFCHs in response to physical sidelink shared channels (PSSCHs) from the COT-initiating UE. The PSFCHs may include hybrid automatic repeat request (HARQ) acknowledgement (HARQ-ACK) information, conflict indication information, or the like. These COT-sharing UEs that transmit PSFCHs are referred to herein as responding UEs. When performing PSFCH transmissions, the responding UEs identify whether they may transmit the PSFCH in a COT shared by the COT-initiating UE by identifying at least one of its PSFCH transmissions in a symbol or slot of an RB set within the multiple RB sets of the COT that are associated with the COT-initiating UE. In additional or alternative aspects, if at least one such PSFCH is scheduled for transmission to the COT-initiating UE within the wideband SL-U COT, the responding UE may also transmit PSFCHs addressed to UEs other than the COT-initiating UE within the shared COT. However, the COT-initiating UE would detect the PSFCHs that are addressed to it. Thus, the COT-initiating UE may not be capable of identifying if some RB sets of the wideband SL-U COT do not include PSFCHs from the responding UEs that are addressed to it (the COT-initiated UE).

Because responding UEs may have PSFCHs associated with the COT-initiating UE and PSFCHs associated with other UEs, the responding UE would schedule such PSFCHs based on multiple considerations, such as a maximum number of PSFCHs that the responding UE can simultaneously transmit, a maximum transmission power allowed, and the like. In order to calculate a transmission power of the scheduled PSFCHs, the responding UEs may use various parameters and measurements, some of which may be provided by a network entity or base station, such as via radio resource control (RRC) signaling. Some of the parameters provided to a responding UE that are used to calculate the transmission power of the scheduled PSFCHs include dl-P0-PSFCH, which corresponds to an indication of the initial power (P0) value for the downlink pathloss-based power control for PSFCH transmissions, dl-alpha-PSFCH, which corresponds to an indication of the alpha or weighted value power for the downlink pathloss-based power control for PSFCH transmissions, and alphaPSFCH, which corresponds to a weighted value related to the PSFCH pathloss.

If dl-P0-PSFCH is provided, the transmission power of PSFCH transmissions can be calculated according to the formula:

$${P}_{PSFCH , one} = {P}_{O , PSFCH} + 10 {log}_{10} ( {2}^{μ} ) + {α}_{PSFCH} \cdot PL [ dBm ] \qquad ( 1 )$$

where P_{O,PSFCH} is a value of dl-P0-PSFCH; α_{PSFCH} is either a value of dl-alpha-PSFCH, if provided, or 1, if dl-alpha-PSFCH is not provided; and PL=PL_{b,f,c}(q_{d}), when the active sidelink bandwidth part (BWP) is on a serving cell, c, except that the reference signal (RS) resource may be the RS the responding UE uses to determine a power of a physical uplink shared channel (PUSCH) transmission scheduled by a DCI format 0_0 in serving cell c when the responding UE is configured to monitor physical downlink control channel (PDCCH) for detection of DCI format 0_0 in the serving cell c. For pathloss estimation, a UE would maintain RS resources corresponding to RS resources indexed by q_{d}, where PL_{b,f,c}(q_{d}) represents the pathloss on an active uplink BWP, b, of a carrier, f, of the serving cell, c. The RS resource may correspond to the synchronization signal (SS)/physical broadcast channel (PBCH) block the responding UE would use to obtain the master information block (MIB) message when the responding UE is not configured to monitor PDCCH for detection of DCI format 0_0 in serving cell c.

When a responding UE supports up to N_{max,PSFCH} simultaneous PSFCH transmissions in a PSFCH transmission occasion and it has N_{sch,Tx,PSFCH} scheduled PSFCHs to be transmitted in the given PSFCH transmission occasion, the responding UE would select N_{Tx,PSFCH} actual PSFCHs transmissions with an ascending order priority rule in the PSFCH transmission occasion based on the type of information carried by the PSFCH. For example, the ascending order priority rule is first applied to PSFCHs carrying HARQ-ACK information, if any, and next, to PSFCHs carrying conflict indication information, if any. In a first scenario, when the number of scheduled PSFCH transmissions, N_{sch,Tx,PSFCH}, is less than or equal to the maximum number of simultaneous PSFCH transmissions, N_{max,PSFCH}, (N_{sch,Tx,PSFCH}≤N_{max,PSFCH}), and dl-P0-PSFCH has been configured or provided, if the total transmission power of the scheduled PSFCHs, N_{sch,Tx,PSFCH}, is equal to or less than the maximum allowed transmission power, P_{CMAX}, such that, P_{PSFCH,one}+10 log₁₀(N_{sch,Tx,PSFCH})≤P_{CMAX}, then the responding UE selects the actual number of PSFCH transmissions, N_{Tx,PSFCH}, to equal the number of scheduled PSFCH transmissions, N_{sch,Tx,PSFCH}, (N_{Tx,PSFCH}=N_{sch,Tx,PSFCH}).

It should be noted that the ascending order priority rule results in first selecting the PSFCH associated with a lowest priority value in the priority value field of the corresponding PSSCH, and then subsequently selecting PSFCHs associated with a next lowest priority value. For example, when the number of scheduled PSFCHs include those carrying HARQ-ACK information and those carrying conflict indication information, the ascending order priority rule would result in first selecting the lowest-to-highest priority values associated with the HARQ-ACK-carrying PSFCHs and then selecting the lowest-to-highest priority values associated with the conflict-indication-information-carrying PSFCHs until the number of actual selected PSFCHs is reached.

In another scenario, when the total transmission power of the N_{sch,Tx,PSFCH} PSFCHs is greater than P_{CMAX}, and dl-P0-PSFCH has been configured, the responding UE may autonomously determine the actual number of PSFCH transmissions, N_{Tx,PSFCH}, first using the ascending order prior rule of the priority field values of the PSFCH transmissions with HARQ-ACK information, if any, and then using the ascending order priority rule of the priority field values of the PSFCH transmissions with conflict indication information, if any, such that the actual number of PSFCH transmissions, N_{Tx,PSFCH}, meets the relation of the following equation:

$${N}_{Tx . PSFCH} \geq max ( 1 , {\sum }_{i = 1}^{K} {M}_{i} ) \qquad ( 2 )$$

where Mᵢ, for 1≤i≤8, is a number of PSFCHs with priority value, i, for PSFCHs carrying HARQ-ACK information and Mᵢ, for i>8, is a number of PSFCHs with priority value i−8 for PSFCHs carrying conflict indication information, and K is defined as the largest value satisfying the relationship of the following equation:

$${P}_{PSFCH , one} + 10 {log}_{10} ( max ( 1 , {\sum }_{i = 1}^{K} {M}_{i} ) ) \leq {P}_{CMAX} \qquad ( 3 )$$

where P_{CMAX} is determined by the responding UE according to standards-based calculations for transmission of all PSFCHs in

$${\sum }_{i = 1}^{K} {M}_{i} ,$$

if any, or zero (0), otherwise, and the power, P_{PSFCH,k}(i), is for a PSFCH transmission, k, wherein 1≤k≤N_{Tx,PSFCH}, is determined according to the following equation:

$${P}_{PSFCH , k} ( i ) = min ( {P}_{CMAX} - 10 {log}_{10} ( {N}_{Tx , PSFCH} ) , {P}_{PSFCH , one} ) [ dBm ] . \qquad ( 4 )$$

where P_{CMAX}−10 log₁₀(N_{Tx,PSFCH}) represents the allowed transmission power at the UE and P_{PSFCH,one} represents the required transmission power.

In another scenario, when the number of scheduled PSFCH transmissions, N_{sch,Tx,PSFCH}, exceeds the maximum number of simultaneous PFSCH transmissions, N_{max,PSFCH}, (N_{sch,Tx,PSFCH}>N_{max,PSFCH}) and dl-P0-PSFCH has been configured, the responding UE first selects N_{max,PSFCH} PSFCHs using the ascending order priority rule of the corresponding priority field values of the PSFCH transmissions carrying HARQ-ACK information, if any, and then also using the ascending order rule of the corresponding priority field values of the PSFCH transmissions carrying conflict indication information, if the total transmission power of N_{max,PSFCH} PSFCHs is equal to or less than the maximum transmission power, P_{CMAX}, according to the relationship of the following equation:

$${P}_{PSFCH , one} + 10 {log}_{10} ( {N}_{max , PSFCH} ) \leq {P}_{CMAX} , \qquad ( 5 )$$

where the actual number of PSFCH transmissions, N_{Tx,PSFCH}, equals the maximum number of simultaneous PSFCHs, N_{max,PSFCH}, and P_{PSFCH,k}(i) P_{PSFCH,one} [dBm].

In another scenario, when the total transmission power of the N_{sch,Tx,PSFCH} PSFCHs is greater than P_{CMAX}, and dl-P0-PSFCH has been configured, the responding UE may autonomously select the actual number of PSFCH transmissions, N_{Tx,PSFCH}, using the ascending order priority rule of corresponding priority field values of the PSFCH transmissions carrying HARQ-ACK information, if any, and then against using the ascending order priority rule of corresponding priority field values of the PSFCH transmissions carrying conflict indication information, if any, such that the number of actual PSFCH transmissions will satisfy the relationship of equation (2), where Mᵢ, 1≤i≤8, is a number of PSFCHs with priority field value, i, for PSFCH carrying HARQ-ACK information and Mᵢ, i>8, is a number of PSFCHs with priority field value, i−8, for PSFCH carrying conflict indication information, and K is defined as the largest value satisfying the relationship of equation (3), where P_{CMAX} is determined by the responding UE according to standards-based calculations for transmission of all PSFCHs in

$${\sum }_{i = 1}^{K} {M}_{i} ,$$

if any, or zero (0), otherwise and P_{PSFCH,k} (i) is determined according to equation (4).

In another scenario where dl-P0-PSFCH is not configured, the responding UE may autonomously determine the actual number of PSFCH transmissions, N_{Tx,PSFCH}, using the ascending order priority rules for the corresponding priority field values of the PSFCH transmissions carrying HARQ-ACK information, if any, and then also using the ascending order priority rule for the corresponding priority field values of the PSFCH transmissions carrying conflict indication information, if any, such that N_{Tx,PSFCH}≥1 and the total power of the actual number of PSFCH transmissions, P_{TX,PSFCH}, is less than or equal to the maximum transmission power, P_{CMAX}.

For UE-to-UE COT sharing in SL-U networks, a responding UE can use the COT shared by the COT-initiating UE when at least one PSFCH transmission of the responding UE is both scheduled within a symbol or slot of one of the RB sets corresponding to the shared COT and intended for the COT-initiating UE. However, due to UE capability or a maximum transmission power constraint, a UE is limited to the maximum number of PSFCHs that can be simultaneously transmitted. When the actual number of simultaneous PSFCHs, N_{Tx,PSFCH}, exceeds the UE capability or the total transmission power of the actual number of simultaneous PSFCHs, P_{Tx,PSFCH}, exceeds the maximum transmission power, P_{CMAX}, the UE will select the PSFCHs for transmission, first, based on the type of information carried by PSFCH, where HARQ-ACK information has a higher priority over conflict indication information, and, secondly, within each information type, by the ascending order priority rule of the priority field value for the given information carried by the PSFCH. This current PSFCH transmission selection procedure was defined for licensed band communications and does not necessarily consider whether the PSFCHs are to be transmitted in a shared COT.

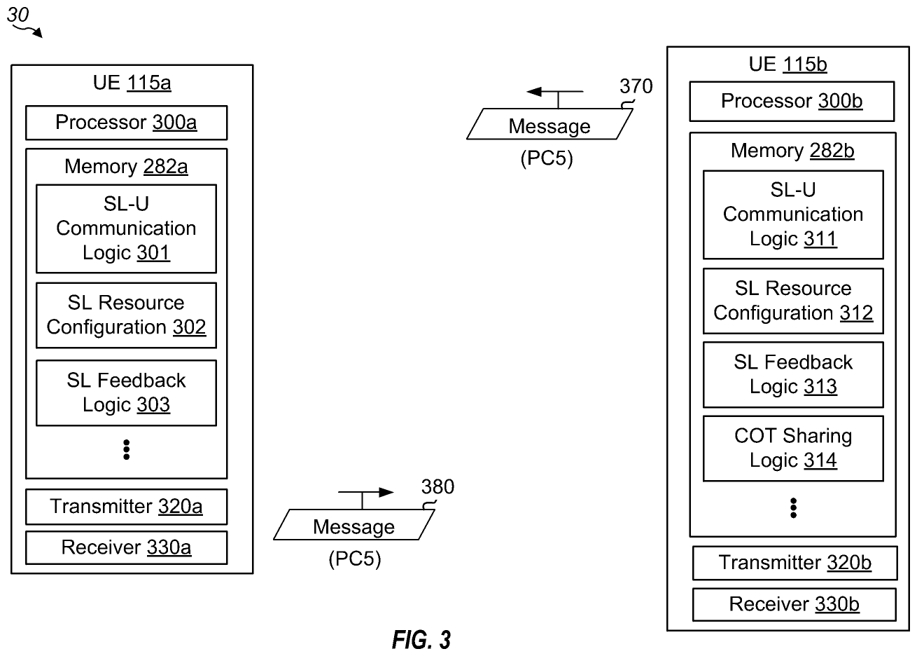

FIG. 3 is a block diagram of an example wireless communications system 300 that supports COT sharing and resuming based on PSFCHs in SL-U wideband operations according to one or more aspects. In some examples, the wireless communications system 300 may implement aspects of the wireless communication system 100. The wireless communications system 300 includes the UE 115s and the UE 115b. Although UEs 115a and 115b are illustrated, in some other implementations, the wireless communications system 300 may generally include multiple UEs 115 and other network nodes, such as one or more network entities, gNBs, and the like.

The UEs 115a and 115b may include a variety of components (such as structural, hardware components) used for carrying out one or more functions described herein. For example, these components may include one or more processors 300a and 300b (hereinafter referred to collectively as “the processor 300a” and “the processor 300b”), one or more memory devices 282a and 282b (hereinafter referred to collectively as “the memory 282a” and “the memory 282b”), one or more transmitters 320a and 320b (hereinafter referred to collectively as “the transmitter 320a” and “the transmitter 320b”), and one or more receivers 330a and 330b (hereinafter referred to collectively as “the receiver 330a” and “the receiver 330b”). The processors 300a and 300b may be configured to execute instructions stored in the memories 282a and 282b, respectively, to perform the operations described herein. In some implementations, the processors 300a and 300b include or correspond, respectively, to one or more of the receive processor 258, the transmit processor 264, and the controller 280 of FIG. 2, and the memories 282a and 282b include or correspond, respectively, to the memory 282 of FIG. 2. The memories 282a and 282b include or are configured, respectively, to store the SL-U communication logic 301, the SL resource configuration 302, the SL feedback logic 303, the SL-U communication logic 311, the SL resource configuration 312, the SL feedback logic 313, and the COT sharing logic 314.

The transmitters 320a and 320b are configured to transmit reference signals, control information, and data from the UEs 115a and 115b to one or more other devices, including to other UEs, such as the other UE, the UEs 115b and 115a, over sidelink interfaces, such as PC5), and the receivers 330a and 330b are configured to receive references signals, synchronization signals, control information and data from one or more other devices, including from other UEs, such as the other UE, the UEs 115b and 115a, over sidelink interfaces. For example, the transmitters 320a and 320b may transmit signaling, control information, and data (respectively, the message 380 and the message 370) to, and the receivers 330a and 330b may receive signaling, control information and data (respectively, the message 370 and the message 380) from, the other UE, the UE 115b and 115a, respectively, via the PC5 sidelink interface. In some implementations, the transmitters 320a and 320b and the receivers 330a and 330b may be integrated in one or more transceivers. Additionally or alternatively, the transmitters 320a and 320b or the receivers 330a and 330b may, respectively, include or correspond to one or more components of the UE 115 described with reference to FIG. 2.

In some implementations, the wireless communications system 300 implements a 5G NR network. For example, the wireless communications system 300 may include multiple 5G-capable UEs 115a and 115b and multiple 5G-capable network entities 105 (FIG. 1), such as UEs and network entities configured to operate in accordance with a 5G NR network protocol such as that defined by the 3GPP.

During operation of the wireless communications system 300, when the code and instructions of the SL-U communication logic 301 and the SL feedback logic 303 are executed by the processor 300a (referred to herein as the “execution environment” of the SL-U communication logic 301 and the SL feedback logic 303), the features and functionality for the UE 115a are enabled that support COT sharing and resuming based on PSFCHs in SL-U wideband operations according to one or more aspects. The execution environment of the SL-U communication logic 301 enables the UE 115a to perform sidelink communications over unlicensed spectrum. The UE 115a may use resource configurations stored in the memory 282a at the SL resource configuration 302 in conjunction with the execution environment of the SL-U communication logic 301 in order to enable a COT to conduct such SL-U communications. The SL-U communication may include transmissions, such as via PSSCH, e.g., the message 380, associated with the UE 115b. The execution environment of the SL feedback logic 303 enables the UE 115a, when acting as a COT-initiating UE, to identify feedback transmissions, such as PSFCHs, that are received from one or more neighboring UEs. For example, with one or more PSSCH transmitted from the UE 115a to the UE 115b, the UE 115a, within the execution environment of the SL feedback logic 303, may expect to receive a PSFCH, e.g., the message 370, from the UE 115b.

In further operation of the wireless communication system 300, the UE 115b may also execute, via the processor 300b, the SL-U communication logic 311, the SL feedback logic 313, which enables the UE 115b, in conjunction with SL resource allocations, stored in the SL resource configuration 312 at the memory 282b, to conduct sidelink communications over unlicensed spectrum. Within the execution environment of the SL-U communication logic 311, the UE 115b may expect to receive a COT-SI message that my identify the wideband SL-U bandwidth of a COT enabled by the UE 115a. The COT-SI message may indicate whether or not the COT created by the UE 115a can be shared. The UE 115b may further receive a PSSCH, the message 380, from the UE 115a via the receiver 330b. Within the execution environments of the SL-U communication logic 311, the SL feedback logic, and the COT sharing logic 314, the UE 115b may generate a feedback message for transmission via a PSFCH, identify whether the PSFCH symbols of the COT may be shared, and then share the COT by transmitting the PSFCH, the message 370, to the UE 115a.

Where the UE 115a identifies that it wants to resume transmission within the COT, within the execution environments for the SL-U communication logic 301 and the SL feedback logic 303, the UE 115a may identify which RB sets of the plurality of RB sets of the SL-U wideband COT have been shared. Such identification may be made upon detecting which RB set the UE 115a receives any PSFCHs on, such as the message 370 from the UE 115b. Once the UE 115a identifies the shared RB sets within the SL-U wideband COT, it may resume transmissions in available RBs of those shared RB sets.

As described with reference to FIG. 3, the present disclosure provides techniques for COT sharing and resuming based on PSFCHs in SL-U wideband operations. Such techniques allow for enhanced COT sharing of wideband SL-U channels, which would allow for more opportunity for the non-COT-initiating UEs to share a COT, while allowing the COT-initiating UE to resume transmissions within the COT by identifying which RB sets in the wideband SL-U COT have been shared. Additional techniques allow the COT-initiating UE to share a COT while ensuring that all RB sets of the wideband SL-U COT can be occupied by the sharing UEs.

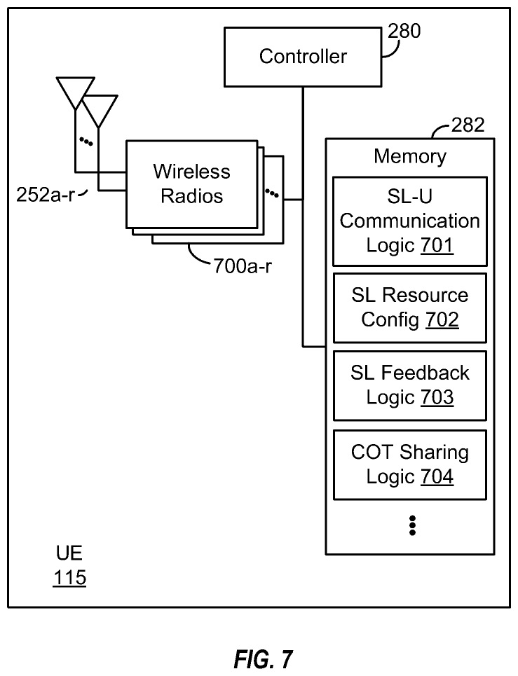

FIG. 4A is a block diagram illustrating an example process 40 that supports COT sharing and resuming based on PSFCHs in SL-U wideband operations according to one or more aspects. Operations of the process 40 may be performed by a UE, such as the UE 115 or 115a described above with reference to FIGS. 1, 2, 3, or a UE described with reference to FIG. 7. For example, example operations (also referred to as “blocks”) of process 40 may enable the UE 115 to support COT sharing and resuming based on PSFCHs in SL-U wideband operations.

At block 400, the UE establishes a COT having a wideband operational frequency associated with a plurality of RB sets. In an SL-U channel, a UE would enable a COT to reserve a portion of the unlicensed channel for communications. The UE may perform an LBT or CCA procedure to first detect whether the channel is occupied before enabling the COT. According to the various aspects described herein, the UE would enable an SL-U wideband COT that is associated with a number of RB sets.

At block 401, the UE transmits over a SL-U channel a COT-SI message that includes a first indication enabling COT sharing with one or more neighboring UEs capable of SL-U communication and a second indication allowing transmission of PSFCHs. After enabling the SL-U wideband COT, the COT-initiating UE transmits a COT-SI that defines the structure of the COT, including the number of RB sets making up the wideband SL-U bandwidth. Additionally, the COT-SI may include an indication of whether the COT is allowed for sharing for PSFCH transmissions. Neighboring UEs may receive this COT-SI and identify whether their communications may be transmitted at shared portions of the COT.

At block 402, the UE completes a first transmission within a portion of the COT. After enabling the COT and sending the COT-SI, the COT-initiating UE may perform its transactions for which it enabled the COT. These transmissions may occur via control signals in PSCCH, data in PSSCH, and the like. In many scenarios, the COT-initiating UE may not have enough transmissions to occupy the entire COT. Thus, the COT-initiating UE indicates the ability to share the COT with neighboring UEs.

At block 403, the UE identifies a second transmission to renew transmissions within the COT. After completing the original transmission in the COT, the COT-initiating UE may discover additional control or data that it would like to send in the COT. Because the COT-initiating UE has initially ceased transmissions, which allows neighboring UEs to share the COT, it will have considerations to make for resuming transmission within the COT.

At block 404, the UE identifies one or more shared RB sets from the plurality of RB sets. Because neighboring UEs may be sharing the COT after the COT-initiating UE finished its initial transmissions, the COT-initiating UE will identify which RB sets of the number of RB sets making up the SL-U wideband COT have been shared with UEs. The COT-initiating UE may identify this by detecting PSFCHs that were associated with and received by the COT-initiating UE.

At block 405, the UE transmits the second transmission using one or more available RBs within the one or more shared RB sets. Once the COT-initiating UE has identified which RB sets of the SL-U wideband COT were shared, the COT-initiating UE may use available RBs within those shared RB sets for resuming its transmissions. To the extent that the COT-initiating UE fails to detect receipt of an PSFCH in some RB sets of the RB sets making up the COT, it will avoid or lose access for resuming transmissions in the COT within those un-shared RB sets.

FIG. 4B is a block diagram illustrating an example process 41 that supports COT sharing and resuming based on PSFCHs in SL-U wideband operations according to one or more aspects. Operations of the process 41 may be performed by a UE, such as the UE 115 or 115b described above with reference to FIGS. 1, 2, 3, or a UE described with reference to FIG. 7. For example, example operations (also referred to as “blocks”) of process 41 may enable the UE 115 to support COT sharing and resuming based on PSFCHs in SL-U wideband operations.

At block 410, the UE receives a COT-SI message from a COT-initiating UE, wherein the COT-SI includes a first indication enabling COT sharing of a COT having a wideband operational frequency associated with a plurality of RB sets and a second indication allowing transmission of PSFCHs. A UE that has the capabilities for sidelink communications over unlicensed spectrum would monitor for and receive COT-SI messages that configure the structure of a COT that has been enabled by a neighboring UE. The COT-SI defines a number of RB sets that make up a SL-U wideband COT as well as potentially indicating whether the COT can be shared for transmission of PSFCH.

At block 411, the UE identifies at least one selected PSFCH of a plurality of selected PSFCHs for transmissions is within an RB of the plurality of RB sets and is associated with the COT-initiating UE. As a non-COT-initiating UE, the UE identifies that it has received PSSCH messages from neighboring UEs, which may include the COT-initiating UE that originated the COT-SI message, and, therefore, would have PSFCH messages to transmit within the SL-U wideband COT. If such UE identifies PSFCHs for transmission, it becomes a responding UE and would identify whether at least one PSFCH that it has selected for transmission is located within one of the RB sets of the SL-U wideband COT and is associated with the COT-initiating UE. If such COT-initiating-UE-addressed PSFCH is identified within the COT, then the responding UE determines it may share the COT. Otherwise, it may not transmit its PSFCHs to the other, non-COT-initiating UEs within the COT.

At block 412, the UE transmits, over a SL-U channel, one or more selected PSFCHs of the plurality of selected PSFCHs in at least one RB set of the plurality of RB sets. If the responding UE identifies that it has at least one COT-initiated-UE-associated PSFCH for transmission within the COT, the responding UE may share the COT and transmit one or more of its scheduled PSFCHs within the COT.

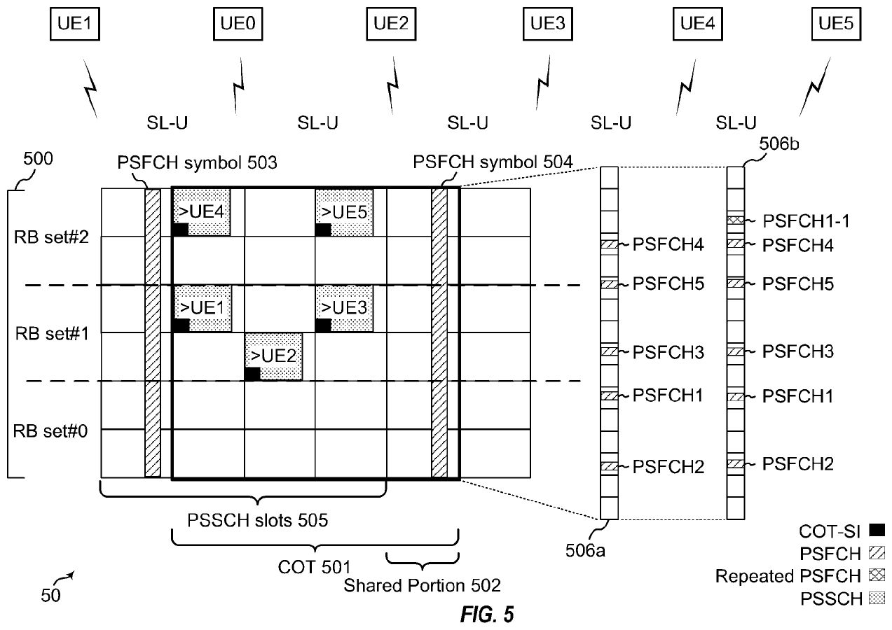

FIG. 5 is a block diagram illustrating an example SL-U network 50 including the UE0-UE5 configured to support COT sharing and resuming based on PSFCHs in SL-U wideband operations according to one or more aspects. The SL-U network 50 includes a wideband SL-U channel 500. The UE1 establishes the COT 501 that includes the RB sets #0-#2 within the wideband SL-U channel 500. The UE1 would transmit a COT-SI that includes information with regard to the COT 501, including an indication of whether COT sharing is allowed for the COT 501 and also whether the COT 501 allows only PSFCH transmissions, only PSSCH transmissions, or both PSFCH and PSSCH transmissions. The PSFCH symbols 503 and 504 provide feedback symbols available for the UE1 and other UEs sharing the COT 501 to provide feedback to any received PSSCHs, including within the PSSCH slots 505. Any of the non-COT-initiating UEs, the UE0 and the UEs 2-5, may share the COT 501 if allowed by the UE1 within the COT-SI transmissions and may transmit PSFCH only, PSSCH only, or both. The UE0 and the UEs2-5 may share the COT 501 for PSFCH, when allowed, by identifying if at least one scheduled PSFCH is scheduled within a symbol or slot of any of the RB sets #0-#2 of the COT 501. If any of the UE0 or the UEs2-5 identify that no PSFCHs are associated with the UE1 within the COT 501, then such non-COT-initiating UE that is responding to a PSSCH received within the PSSCH slots 505, a responding UE, may not share the COT 501.

The COT-initiating UE, the UE1, identifies whether partial sharing is allowed by identifying that it has information to resume transmissions within the COT 501. For example, the UE1 transmits a PSSCH, the >UE1, within the PSSCH slots 505, to the UE0. If the UEL further identifies information that it can transmit further within the COT 501, partial sharing of the remaining RBs of the COT 501 is enabled. In order to resume transmissions within the COT 501, the COT-initiating UE, the UE1, identifies which RB sets of the RB sets #0-#2 have been shared with other UEs based on received PSFCHs. As noted above, the responding UEs, the UE0 and the UEs2-5, identify whether to share the COT 501 by identifying at least one PSFCH scheduled for the COT-initiating UE, the UEL, scheduled in a slot or symbol of one of the RB sets #0-#2. That COT sharing identification process does not guarantee that there will be a PSFCH transmission associated with the COT-initiating UE, the UE1, in each of the RB sets #0-#2 of the COT 501. Thus, where the COT-initiating UE, the UE1, does not receive a PSFCH transmission within a slot or symbol of any of the RB sets #0-#2, it will avoid or lose transmission access to that RB set for the remainder of the COT 501.

As illustrated in FIG. 5, the UE0 receives PSSCH transmissions within the PSSCH slots 505 from the UE4, the >UE4, and UE5, the >UE5, in the RB set #2, from the COT-initiating UE, the UE1, the >UE1, the UE2, the >UE2, and the UE3, the >UE3, in the RB set #1. The UE0 does not receive any PSSCHs in the RB set #0. The UE0 schedules PSFCH transmissions corresponding to the received PSSCHs, the >UE1, the >UE2, the >UE3, the >UE4, and the >UE5, for the PSFCH symbols 504. The scheduled PSFCH transmissions is reflected at the scheduled PSFCHs 506a. For purposes of the example aspect, each of the PSFCH scheduled by the UE0 carries the same information, such as all carrying HARQ-ACK information, or all carrying conflict indication information. According to the ascending order priority rule the priority of scheduled PSFCH transmissions in the scheduled PSFCHs 506a corresponds to the relation in the following equation:

$$PSFCH 2 = PSFCH 5 > PSFCH 4 > PSFCH 3 > PSFCH 1 \qquad ( 6 )$$

In such a scenario, the COT-initiating UE, the UE1, receives a PSFCH in RB set #1 and not in either of the RB set #0 or #2. Accordingly, the COT-initiating UE, the UE1, will avoid or lose access to resuming transmissions in both the RB set #0 and #2.

In an optional aspect of the present disclosure, when any of the responding UEs, the UE0 and the UEs2-5, identify one or more scheduled PSFCHs to other UEs in one or more RB set of the RB sets #0-#2 and no PSFCH scheduled in those RB sets associated with the COT-initiating UE, the UE1, the responding UE, any of the UE0 or the UEs2-5, will repeat a PSFCH transmission to the COT-initiating UE, the UE1, in those RB sets where no such COT-initiating-UE-associated PSFCH is scheduled. For example, as illustrated at the scheduled PSFCHs 506b, because the UE0 identifies that in the RB set #2, it has scheduled PSFCHs to the UE4, the PSFCH4, and the UE5, the PSFCH5, but not to the UE1, the UE0 schedules a repeated PSFCH transmission, the PSFCH1-1, which is a repeat of the PSFCH associated with the UE1 in the RB set #1, the PSFCH1. The repeated PSFCHs to the COT-initiating UE, UE1, of the optional aspect ensures that each RB set which is occupied by the responding UE, the UE0, in the shared wideband COT, the COT 501, has at least one PSFCH for the COT-initiating UE, the UE1. For purposes of this optional aspect, each of the PSFCH scheduled by the UE0 carries the same information, such as all carrying HARQ-ACK information, or all carrying conflict indication information. According to the ascending order priority rule the priority of scheduled PSFCH transmissions in the scheduled PSFCHs 506b corresponds to the relation in the following equation:

$$PSFCH 2 = PSFCH 5 > PSFCH 4 > PSFCH 3 > PSFCH 1 = PSFCH 1 - 1 \qquad ( 7 )$$

A value, Y, is used to represent the PSFCH index of a specific PSFCH and, with respect to the example aspect illustrated in FIG. 5, is identified by the index of the specific PSFCH which can make sure that each of the RB sets occupied by a responding UE, the UE0, in the shared wideband COT, the COT 501, has at least one PSFCH for the COT-initiating UE, the UE1, where, according to equation (7), Y=6, such that N_{Tx,PSFCH}≥6. As the UE0 may transmit PSFCHs associated with the UE1 in both the RB set #1 (the PSFCH1) and the RB set #2 (the PSFCH1-1), the UE1 would identify received PSFCHs in the RB sets #1 and #2 and only avoid or lose resumed transmission access to the RB set #0.

In one implementation of the optional aspect, the responding UE, the UE0, determines the value of NX,PSFCH based on whether each RB set that the responding UE, the UE0, occupies in the COT 501 has at least one PSFCH for the COT-initiating UE, the UE1. That determination results in the priority of PSFCHs indicated in equation (7), wherein the number of actual PSFCHs transmitted, N_{Tx,PSFCH}, is at least 6 (N_{Tx,PSFCH}≥6).

In another implementation of the optional aspect, the responding UE, the UE0, selects the actual number of PSFCHs for transmissions, N_{Tx,PSFCH}, to make sure that each RB set that the UE0 occupies in the COT 501 has at least one PSFCH for COT initiator. This different implementation results in a different priority according to the relation in the following equation:

$$PSFCH 1 = PSFCH 1 - 1 > PSFCH 2 = PSFCH 5 > PSFCH 4 > PSFCH 3 \qquad ( 8 )$$

Where the PSFCH associated with the UE1 in RB set #1, the PSFCH1, and the repeated PSFCH for UE1 in RB set #2, the PSFCH1-1 are increased in the transmission order in order to increase the probability that they are transmitted in case the maximum number of simultaneous PSFCHs would be less than the scheduled number of PSFCHs.

It should be noted that when there are more than one PFSCHs scheduled by the responding UE for the COT-initiating UE, the responding UE selects to repeat the PFSCH corresponding to the PSSCH having either the highest or lowest priority value.

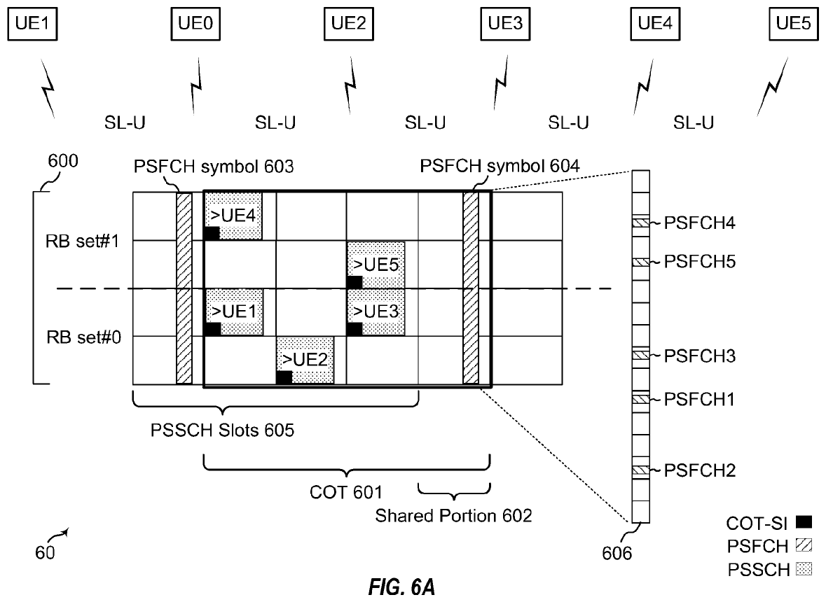

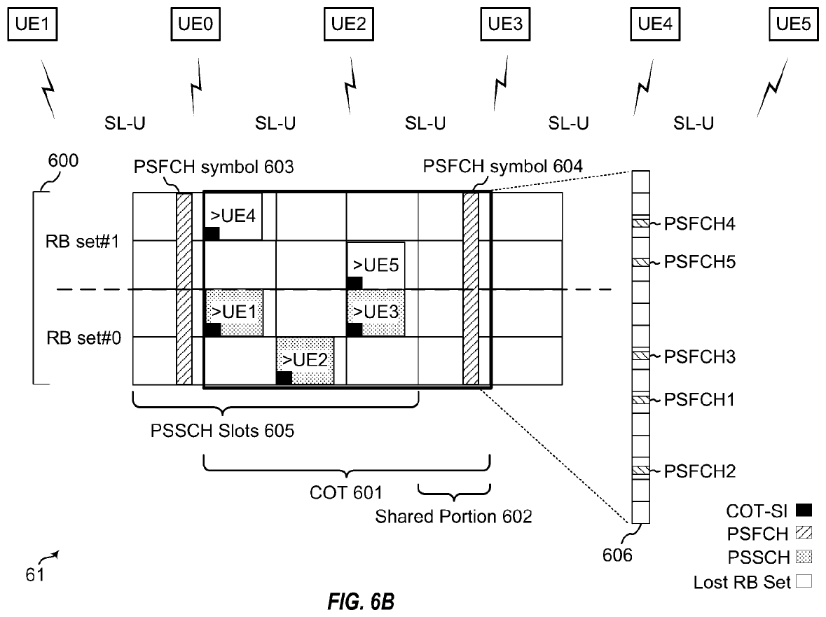

FIG. 6A is a block diagram illustrating an example SL-U network 60 including the UE0-UE5 configured to support COT sharing and resuming based on PSFCHs in SL-U wideband operations according to one or more aspects. The SL-U network 60 includes a wideband SL-U channel 600. The UE1 establishes the COT 601 that includes the RB sets #0-#1 within the wideband SL-U channel 600. The UE1 would transmit a COT-SI that includes information with regard to the COT 601, including an indication of whether COT sharing is allowed for the COT 601 and also whether the COT 601 allows PSFCH transmissions, PSSCH transmissions, or both. The COT-SI also includes an indication of a required shared bandwidth, which may be configured by the indication as a specified number of RB sets of the total RB sets defining the COT that must be occupied by responding UEs that identify to share the COT or that the entire wideband SL-U channel 600, including all RB sets comprising the COT 601, must be occupied. The PSFCH symbols 603 and 604 provide feedback symbols available for the COT-initiating UE, the UE1, and other UEs sharing the COT 601 to provide feedback to any received PSSCHs, including within the PSSCH slots 605.

It should be noted that when identifying the specified number of RB sets of the required shared bandwidth, the specific RB sets of the total wideband SL-U channel 600 may be dynamically selected by the COT-initiating UE, the UE1, based on various factors, such as scheduled transmissions, channel quality information, and the like. Alternatively, a serving network entity within the coverage area may designate a specified set of RB sets within the total wideband SL-U channel 600 for the required shared bandwidth.

In a first optional aspect illustrated by FIG. 6A, the COT-initiating UE, the UE1, may communicate with a non-COT-initiating UE, the UE0, via PSSCH, the >UE1, within the PSSCH slots 605. Thus, the UE1 shares the COT 601 with those responding UEs when PSFCHs associated with the COT-initiating UE, the UE1, can occupy each RB set of the required shared bandwidth. In a second optional aspect illustrated by FIG. 6A, responding UEs identify when they may share the COT 601 when they identify one of their scheduled PSFCHs in each RB of the required shared bandwidth and at least one PSFCH transmission associated with the UE1 in a symbol or slot within the RB set #0 or the RB set #1 of the COT 601. For example, the COT-SI from the COT-initiating UE, the UE1, identifies the wideband bandwidth of the COT 601, the RB sets #0-#1, as the required shared bandwidth. The UE0 receives PSSCHs, the >UE1, the >UE2, the >UE3, the >UE4, and the >UE5, the from the UEs1-5, respectively, during PSSCH slots 605 and, thus, will have corresponding PSFCHs for transmission during the PSFCH symbol 604. Thus, the UE0, as a responding UE, will identify the PSFCH1, the PSFCH2, and the PSFCH3 for transmission in RB set #0 and the PSFCH 4 and the PSFCH5 for transmission in RB set #1 in the scheduled PSFCHs 606. The responding UE, the UE0, identifies it can share the COT 601, as it has PSFCH transmissions that can occupy the required shared bandwidth of the COT 601 and has at least one PSFCH associated with the UE1 within RB set #0.

The responding UE, the UE1, identifies the number of the actual transmitted PSFCHs, N_{Tx,PSFCH}, based on whether PSFCH transmissions can occupy each RB set of required shared bandwidth and at least one PSFCH transmission from the UE0 to the UE1 within an RB set corresponding to the COT 601. In a first example scenario, when the actual number of transmitted PSFCHs, N_{Tx,PSFCH}, exceeds a maximum number of simultaneous PSFCHs, N_{Tx,PSFCH}≤N_{max,PSFCH}, and the parameter, dl-P0-PSFCH, is configured, if the total transmission power of the number of scheduled PSFCH transmissions, N_{sch,Tx,PSFCH}, is larger than a maximum transmission power, P_{CMAX}, the actual number of transmitted PSFCHs may be determined according to the relation of the following equation: GP

$${N}_{Tx , PSFCH} \geq X \underline{>} 1 \qquad ( 9 )$$

### Where

$$X = max ( {\sum }_{i = 1}^{K} {M}_{i} , Y ) ,$$

K represents the largest value that the total transmission power of all X PSFCHs is no larger than P_{CMAX}, Mᵢ represents a number of PSFCHs with priority field value, i, and Y represents the PSFCH index of a specific PSFCH, where the PSFCH is indexed according to the ascending order priority rule based on the type of information carried by the PSFCH. For PSFCH transmissions having the same priority, the PSFCH transmissions may be indexed based on time domain and/or frequency domain location of its associated PSSCH transmission.

In a first alternative implementation illustrated by FIG. 6A, the specific PSFCH may be identified as the first PSFCH that ensures at least one PSFCH is transmitted in each RB set of the required shared bandwidth of the COT 601. In a second alternative implementation illustrated by FIG. 6A, the specific PSFCH may be identified as the first PSFCH that ensures at least one PSFCH is transmitted in each RB set of the required shared bandwidth of the COT 601 and at least one PSFCH associated with the COT-initiating UE, the UE1, is transmitted in the COT 601.

The responding UE, the UE0, selects the number of scheduled PSFCHs based on the ascending order priority rule in consideration of the type of information carried by the PSFCH. The UE0 would then select the scheduled PSFCHs according to the relation in the following equation:

$$PSFCH 2 > PSFCH 4 = PSFCH 5 > PSFCH 3 > PSFCH 1 \qquad ( 10 )$$

The power for transmission of all five PSFCHs of equation (10) may be calculated against the maximum transmission power, P_{CMAX}, according to the following equation:

$${P}_{P S F C H 2} + {P}_{P S F C H 4} + {P}_{P S F C H 5} + {P}_{P S F C H 3} + {P}_{P S F C H 1} > {P}_{CMAX} \qquad ( 11 )$$

Thus, the transmission power for all five of the scheduled PSFCHs, N_{sch,Tx,PSFCH}, exceeds the maximum transmission power, P_{CMAX}. For purposes of this example, the maximum number of simultaneous PSFCHs is set to five, N_{max,PSFCH}=5. Thus, the number of scheduled PSFCHs, N_{sch,Tx,PSFCH}, also exceeds the maximum number of simultaneous PSFCHs, N_{max,PSFCH}.

The responding UE, the UE0, may then select the N_{max,PSFCH} PSFCHs from equation (10) to comply with the N_{max,PSFCH}=5 restriction. Based on the priority illustrated in equation (10), the UE0 would select the PSFCH2, the PSFCH4, the PSFCH5, the PSFCH3, and the PSFCH1 for the N_{Tx,PSFCH} PSFCHs. The total transmission power for all of such PSFCH transmissions may be calculated against the maximum transmission power, P_{CMAX}, in the following equation:

$${P}_{P S F C H 2} + {P}_{P S F C H 4} + {P}_{P S F C H 5} + {P}_{P S F C H 3} + {P}_{P S F C H 1} \leq {P}_{CMAX} \qquad ( 12 )$$

where

$${N}_{Tx , PSFCH} \geq X = max ( {\sum }_{i = 1}^{K} {M}_{i} , Y ) = max ( {M}_{1} + {M}_{2} + {M}_{3} , Y ) .$$

Of the 5 PSFCHs to be transmitted, two share the same priority, the PSFCH4 and the PSFCH5, thus, the values of Mᵢ reflect, Mᵢ=1 (the PSFCH2), M₂=2 (the PSFCH4 & the PSFCH5), M₃=1 (the PSFCH3), M₄=1 (the PSFCH1), such that M₁+M₂+M₃+M₄=5. In determining Y according to the first alternative implementation, the UE0 identifies a PSFCH that occupies the RB set #0 and a PSFCH that occupies RB set #1, which satisfies the restriction to occupy each RB set within the required shared bandwidth of the COT 601. Therefore, according to the first alternative implementation, the UE0, determines Y=2. The equation for

$$X = max ( {\sum }_{i = 1}^{K} {M}_{i} , Y ) = max ( 5 , 2 ) = 5 .$$

In determining Y according to the second alternative implementation, the UE0 identifies a PSFCH that not only occupies each RB set of the COT 601, the RB set #0 and the RB set #1, but also identifies at least one PSFCH that is associated with the COT-initiating UE, the UE1, within the COT 601. Based on the priority of PSFCHs in equation (10), the PSFCH1 is last in the priority, thus, Y=5. However, as Y=5>N_{max,PSFCH}, Y would also be determined according to

$${\sum }_{i = 1}^{K} {M}_{i} .$$

Thus, the equation for

$$X = max ( {\sum }_{i = 1}^{K} {M}_{i} , Y = {\sum }_{i = 1}^{K} {M}_{i} ) = max ( 5 , 5 ) = 5.$$

In a second example scenario illustrated by FIG. 6A, when the number of scheduled PSFCHs, N_{sch,Tx,PSFCH}, exceeds the maximum number of simultaneous PSFCHs, N_{sch,Tx,PSFCH}>N_{max,PSFCH}, and the parameter, dl-P0-PSFCH, is configured, the responding UE, the UE0, first selects N_{max,PSFCH} PSFCHs based on the ascending order priority rule and then selects the actual number of PSFCHs, N_{Tx,PSFCH}, from the N_{max,PSFCH} PSFCHs, where N_{Tx,PSFCH}≥X≥1 and

$$X = max ( {\sum }_{i = 1}^{K} {M}_{i} , Y ) ,$$

where K represents the largest value that the total transmission power of all X PSFCHs is no larger than P_{CMAX}, Mᵢ represents a number of PSFCHs with priority field value, i, and Y represents the PSFCH index of a specific PSFCH if the PSFCH index is no larger than N_{max,PSFCH}, otherwise,

$$Y = {\sum }_{i = 1}^{K} {M}_{i} .$$

It should be noted that the specific PSFCH may be identified according to the first alternative implementation or the second alternative implementation noted above.

In a third example scenario illustrated by FIG. 6A, when the parameter, dl-P0-PSFCH, is not configured, the responding UE, the UE0, selects the N_{Tx,PSFCH} PSFCH transmissions based on the ascending order priority rule, where the actual number of transmitted PSFCHs may be determined according to the relation in the following equation:

$${N}_{Tx , PSFCH} \geq Y \underline{>} 1 \qquad ( 13 )$$

where Y represents the PSFCH index of a specific PSFCH, in which the specific PSFCH may also be determined according to the first alternative implementation or the second alternative implementation noted above.

In a third optional aspect illustrated by FIG. 6A, the responding UE, the UE0, selects N_{Tx,PSFCH} PSFCHs based on whether PSFCH transmissions can occupy each RB set of the required shared bandwidth and at least one of the UE0's PSFCH transmissions associated with the COT-initiating UE, the UE1, is in a symbol or slot within an RB set of the COT 601. In another example scenario illustrated by FIG. 6A, when the number of scheduled PSFCHs, N_{sch,Tx,PSFCH}, is less than or equal to the maximum number of simultaneous transmissions, N_{sch,Tx,PSFCH}≤N_{max,PSFCH}, and the parameter, dl-P0-PSFCH, has been configured, if the total transmission power of N_{sch,Tx,PSFCH} PSFCHs is larger than P_{CMAX}, the UE0 selects the N_{Tx,PSFCH} PSFCH based on one of the following rules, where

$${N}_{TX , PSFCH} \geq X \geq 1 , X = max ( {\sum }_{i = 1}^{K} {M}_{i} , Y ) ,$$

where K represents the largest value that the total transmission power of all X PSFCHs is no larger than P_{CMAX}, Mᵢ represents a number of PSFCHs with priority field value, i, and Y represents the PSFCH index of a specific PSFCH if the PSFCH index is no larger than N_{max,PSFCH}, otherwise,

$$Y = {\sum }_{i = 1}^{K} {M}_{i} .$$

In one alternative implementation illustrated by FIG. 6A, if the total transmission power of the scheduled N_{sch,Tx,PSFCH} PSFCHs exceeds the maximum transmission power, P_{CMAX}, per RB set of required shared bandwidth, the responding UE, the UE0, may first select a PSFCH associated with the lowest priority field value of the corresponding PSFCH in the scheduled PSFCHs 606 or the PSFCH associated with the earliest slot, when there are multiple in-COT PSFCHs that have the same priority, for the scheduled PSFCHs 606, and then may select the PSFCHs over the remaining scheduled PSFCHs transmissions, in the scheduled PSFCHs 606, using the ascending order priority rule based on the corresponding priority field values of the remaining scheduled PSFCH transmissions, in the scheduled PSFCHs 606, carrying HARQ-ACK information, if any, and then again using the ascending order priority rule of priority field values of the remaining scheduled PSFCH transmissions, in the scheduled PSFCHs 606, carrying conflict indication information, if any.

In another alternative implementation illustrated by FIG. 6A, if the total transmission power of the scheduled N_{sch,Tx,PSFCH} PSFCHs, the scheduled PSFCHs 606, exceeds the maximum transmission power, P_{CMAX}, the responding UE, the UE0, first may select a PSFCH associated with the lowest priority field value of the corresponding PSFCH in the scheduled PSFCHs 606 or the PSFCH associated with the earliest slot, when there are multiple scheduled PSFCHs in the scheduled PSFCHs 606 associated with the COT-initiating UE, the UEL, that have the same priority, for the PSFCH transmissions, and then, except for the one or more RB sets of the COT 601 which have a PSFCH associated with the COT-initiating UE, the UE1, for the remaining RB sets of the required shared bandwidth, the RB set #0 and the RB set #1, select a PSFCH, per RB set, associated with the lowest priority field value of the remaining PSFCHs of the scheduled PSFCHs 606 or select the PSFCH, per RB set, associated with the earliest slot, when there are multiple in-COT PSFCHs that have the same priority. The responding UE, the UE0, then may select PSFCHs over the remaining PSFCHs transmissions of the scheduled PSFCHs 606 using the ascending order priority rule of the corresponding priority field values of the remaining PSFCH transmissions in the scheduled PSFCHs 606 carrying HARQ-ACK information, if any, and then using the ascending order priority rule of the remaining PSFCH transmissions of in the scheduled PSFCHs 606 carrying conflict indication information, if any.

In another example scenario illustrated by FIG. 6A, when the number of scheduled PSFCH, N_{sch,Tx,PSFCH}, exceeds the maximum number of simultaneous PSFCHs, N_{sch,Tx,PSFCH}>N_{max,PSFCH}, and the parameter, dl-P0-PSFCH, has been configured, the responding UE, UE0, may select N_{max,PSFCH} PSFCHs either (1) according to the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCHs, or (2) to ensure at least one COT-initiating-UE-addressed PSFCH of the N_{Tx,PSFCH} PSFCHs is transmitted in each RB set of the COT 601 occupied by a PSFCH transmission of the responding UE, the UE0, where the number of the plurality of selected PSFCHs, N_{Tx,PSFCH}≥X≥1, where

$$X = max ( {\sum }_{i = 1}^{K} {M}_{i} )$$

and a total transmission power of the plurality of selected PSFCHs, P_{Tx,PSFCH}, is less than or equal to a maximum transmission power, P_{CMAX}.

In another example scenario illustrated by FIG. 6A, when the parameter, dl-P0-PSFCH, has not been configured, the responding UE, the UE0, may select the N_{Tx,PSFCH} PSFCH transmissions either (1) according to the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCHs, or (2) to ensure at least one COT-initiating-UE-addressed PSFCH of the N_{Tx,PSFCH} PSFCHs is transmitted in each RB set of the COT 601 occupied by a PSFCH transmission of the responding UE, the UE0, where the number of the plurality of selected PSFCHs, N_{Tx,PSFCH}≥X≥1, where

$$X = max ( {\sum }_{i = 1}^{K} {M}_{i} )$$

and a total transmission power of the plurality of selected PSFCHs, P_{Tx,PSFCH}, is less than or equal to a maximum transmission power, P_{CMAX}

For purposes of this other example scenario, the maximum number of simultaneous PSFCHs is set to four, N_{max,PSFCH}=4. The responding UE, the UE0, uses the ascending order priority rule based on the type of information carried by the PSFCHs in the scheduled PSFCHs 606 to prioritize the PSFCH transmissions. In this other example scenario, the UE0 identifies the priority of PSFCH transmissions according to the relation in the following equation:

$$PSFCH 2 = PSFCH 5 > PSFCH 4 > PSFCH 3 > PSFCH 1 \qquad ( 14 )$$

According to the one alternative implementation noted above, the UE0 may select the four PSFCHs from the priority of PSFCHs in equation (14) by prioritizing occupation of the required shared bandwidth with at least one PSFCH in each of the RB set #0 and the RB set #1. Accordingly, the UE0 would select the PSFCH2, the PSFCH5, the PSFCH4, and the PSFCH3 for transmission.

Conversely, according to the another alternative implementation noted above, the UE0 may select the four PSFCHs from the priority of PSFCHs in equation (14) by prioritizing not only occupation of the required shared bandwidth, but also that at least one PSFCH associated with the COT-initiating UE, the UE1, is located within at least one RB set of the required shared bandwidth. Accordingly, the UE0 would select the PSFCH1, the PSFCH5, the PSFCH2, and the PSFCH4 for transmission.

FIG. 6B is a block diagram illustrating an example SL-U network 61 including the UE0-UE5 configured to support COT sharing and resuming based on PSFCHs in SL-U wideband operations according to one or more aspects. The SL-U network 61 includes the wideband SL-U channel 600. The UE1 establishes the COT 601 that includes the RB sets #0-#1 within the wideband SL-U channel 600. The UE1 would transmit a COT-SI that includes information with regard to the COT 601, including an indication of whether COT sharing is allowed for the COT 601 and also whether the COT 601 allows PSFCH transmissions, PSSCH transmissions, or both. The PSFCH symbols 603 and 604 provide feedback symbols available for the COT-initiating UE, the UE1, and other UEs sharing the COT 601 to provide feedback to any received PSSCHs, including within the PSSCH slots 605.

The operation of partial sharing may be conditions based on various circumstances. In certain aspects, partial sharing may always be allowed. In such cases, the non-COT-initiating UEs, the UE0 and the UEs2-5, may share the COT 601 for PSFCH transmissions where such non-COT-initiating UE can meet the underlying condition of having at least one PSFCH associated with the COT-initiating UE, the UE1, in a slot or symbol within the COT 601. In alternative aspects, the COT-initiating UE, the UE1, may condition partial sharing based on the priority between PSFCHs and PSSCHs which are to be transmitted by the UE1. In such alternative aspects, the COT-initiating UE, the UE1, may select the highest priority among the PSFCHs and the PSSCHs to be transmitted by the UE1 within any of RB set #0 or RB set #1 of the COT 601. When the PSFCH transmission has higher priority than the PSSCH transmissions, then partial sharing is allowed. Otherwise, the COT-initiating UE, the UE1, includes the indication of a required shared bandwidth in the COT-SI, which may be configured by the indication as a specified number of RB sets of the total RB sets associated with the COT that is required to be occupied by responding UEs in order to partially share the COT 601.

In the aspects where partial sharing is always allowed or the alternative aspects, in which the COT-initiating UE, the UE1, identifies to allow partial sharing upon meeting of a condition, such as when the UE1-scheduled PSFCHs have a higher priority than the UE1-scheduled PSSCHs within the COT 601, the non-COT-initiating UEs, the UE0 and the UEs2-5, may identify whether they are allowed to share the COT 601 based on the meeting the condition that at least one of its PSFCHs associated with the COT-initiating UE, the UE1, will be transmitted within a slot or symbol within the COT 601.

As illustrated in FIG. 6B, the UE0 receives multiple PSSCHs, within the PSSCH slots 605 and would have responding PSFCHs for the PSFCH symbols 604. As the responding UE, the UE0 identifies its scheduled PSFCHs for the scheduled PSFCHs 606 as the PSFCH1, the PSFCH2, and the PSFCH3 in the RB set #0 and the PSFCH4 and the PSFCH5 in the RB set #1, the UE0 identifies that it may share the COT 601. The UE0 may then prioritize the scheduled PSFCHs of the scheduled PSFCHs 606 using the ascending order priority rule based on the type of information carried by the PSFCH. The UE0 would result in the priority of PSFCHs according to the relation reflected in the following equation:

$$PSFCH 2 > PSFCH 1 = PSFCH 3 > PSFCH 4 > PSFCH 5 \qquad ( 15 )$$

For purposes of the example implementation, the maximum number of simultaneous PSFCHs, N_{max,PSFCH}, is set to three, N_{max,PSFCH}=3. Thus, the UE0 would select three PSFCHs for transmission from the priority noted in equation (15), the PSFCH2, the PSFCH1, and the PSFCH3 all scheduled for transmission in the RB set #0. When the COT-initiating UE, the UE1, identifies it wants to resume transmissions in the COT 601, it will identify which RB sets that it received PSFCHs in order to identify which RB sets of the COT 601 have been shared. Because the UE1 receives a PSFCH in the RB set #0 and not in the RB set #1, the UE1 will avoid or lose transmission access to the RB set #1 for the remainder of the COT 601.

In the alternative aspects, where the COT-initiating UE, the UE1, identifies that the condition for partial sharing has not been met, such as, in certain aspects, where the UE1 finds that the priority of its scheduled PSSCHs is higher than the priority of its PSFCHs within the COT 601, the COT-initiating UE, the UE1, adds an indication to the COT-SI of a required shared bandwidth, which, for purposes of the described example implementation, may be configured by the indication as the entire SL-U wideband bandwidth of the COT 601, including the RB set #0 and the RB set #1, that must be occupied by responding UEs in order to partially share the COT 601.

As the responding UE, the UE0 identifies its scheduled PSFCHs for the scheduled PSFCHs 606 and then prioritize the scheduled PSFCHs using the ascending order priority rule based on the type of information carried by the PSFCH. The UE0 would result in the priority of PSFCHs according to the relation reflected in equation (15). For purposes of the described example implementation, the maximum number of simultaneous PSFCH transmissions, N_{max,PSFCH}, is set to three, N_{max,PSFCH}=3. When identifying the PSFCHs for transmission from the prioritized PSFCHs of equation (15) according to the first alternative implementation described above, the UE0 would identify the number of actually transmitted PSFCHs, N_{Tx,PSFCH}, according to N_{Tx,PSFCH}≥X≥1, where

$$X = max ( {\sum }_{i = 1}^{K} {M}_{i} , Y ) ,$$

K represents the largest value that the total transmission power of all X PSFCHs is no larger than P_{CMAX}, Mᵢ represents a number of PSFCHs with priority field value, i, and Y represents the PSFCH index of a specific PSFCH, where the PSFCH is indexed according to the ascending order priority rule based on the type of information carried by the PSFCH. In such first alternative implementation, the UE0 determines Y=4 and X=4, thus, will select four PSFCHs for transmission: the PSFCH2, the PSFCH1, the PSFCH3, and the PSFCH4. When identifying the PSFCHs for transmission from the prioritized PSFCHs of equation (15) according to the second alternative implementation described above, the UE0 would again identify the number of actually transmitted PSFCHs, N_{Tx,PSFCH}, according to N_{Tx,PSFCH}≥X≥1, where

$$X = max ( {\sum }_{i = 1}^{K} {M}_{i} , Y ) ,$$

which, again, results in Y=4 and X=4. Because one of the higher priority PSFCHs include the PSFCH1 associated with the COT-initiating UE, the UE1, will be transmitted within the COT 601, the UE0 will select the same four PSFCHs for transmission: the PSFCH2, the PSFCH1, the PSFCH3, and the PSFCH4.

The UE0 may also select the number of actually transmitted PSFCHs using the one alternative implementation discussed above. In such implementation, the UE0 determines that the total transmission power of the scheduled N_{sch,Tx,PSFCH} PSFCHs exceeds the maximum transmission power, P_{CMAX}. In such case, the UE0 selects N_{max,PSFCH} PSFCH transmissions from the prioritized scheduled PSFCHs of equation (15) in order to further prioritize occupation of the required shared bandwidth. The UE0 would, therefore, select the PSFCH2, the PSFCH4, and the PSFCH 1.

The UE0 may also select the number of actually transmitted PSFCHs using the another alternative implementation discussed above. In such implementation, the UE0 determines that the total transmission power of the scheduled N_{sch,Tx,PSFCH} PSFCHs, the scheduled PSFCHs 606, exceeds the maximum transmission power, P_{CMAX}. In response, the responding UE, the UE0, selects N_{max,PSFCH} PSFCH transmissions from the prioritized scheduled PSFCHs of equation (15) in order to prioritize both occupation of the required shared bandwidth and at least one PSFCH transmission associated with the COT-initiating UE, the UE1. The UE0 would, therefore, select the PSFCH1, the PSFCH4, and the PSFCH2 for transmission.

FIG. 7 is a block diagram of an example UE 115 that supports COT sharing and resuming based on PSFCHs in SL-U wideband operations according to one or more aspects. The UE 115 may be configured to perform operations, including the blocks of a process described with reference to FIGS. 4A and 4B. In some implementations, the UE 115 includes the structure, hardware, and components shown and described with reference to the UE 115 of FIGS. 1-3. For example, the UE 115 includes the controller 280, which operates to execute logic or computer instructions stored in the memory 282, as well as controlling the components of the UE 115 that provide the features and functionality of the UE 115. The UE 115, under control of the controller 280, transmits and receives signals via the wireless radios 700a-r and the antennas 252a-r. The wireless radios 700a-r include various components and hardware, as illustrated in FIG. 2 for the UE 115, including the modulator and demodulators 254a-r, the MIMO detector 256, the receive processor 258, the transmit processor 264, and the TX MIMO processor 266.

As shown, the memory 282 may include SL-U communication logic 701, SL resource configuration 702, SL feedback logic 703, and COT sharing logic 704. The SL-U communication logic 701, when executed by the controller 280 may enable the functionality within the UE 115 for performing sidelink communications over unlicensed spectrum using the wireless radios 700a-r and the antennas 252a-r. The execution environment of the SL-U communication logic 701 would enable the UE 115, as a COT-initiating UE, to enable an SL-U wideband COT, in some circumstances after performing an LBT procedure, using the SL resource allocations found in the SL resource configuration 702 in the memory 282, and send transmissions within the COT via the wireless radios 700a-r and the antennas 252a-r. As a responding UE, the execution environment of the SL-U communication logic 701 would enable sidelink communications over the unlicensed spectrum, enable recognition of COT-SI messages, received via the antennas 252a-r and the wireless radios 700a-r, that define the structure of a particular SL-U wideband COT, and identifying indications of whether the COT is available for sharing. The SL feedback logic 703, when executed by the controller 280, enables the UE 115, as a COT-initiating UE, to detect PSFCH feedback sent from responding UEs to which UE 115, as the COT-initiating UE, transmitted a PSSCH message within the COT via the wireless radios 700a-r and the antennas 252a-r. For the UE 115 as a responding UEs, the execution environment of the SL feedback logic 703 enables the UE 115 to generate a PSFCH in response to the PSSCH received from the COT-initiating UE. The COT sharing logic 704, when executed by the controller 280, enables the UE 115, as a responding UE, to identify when and how to share a COT. For example, when the UE 115 identifies, within the execution environments of the SL communication logic 701 and the SL feedback logic 703, that is has PSFCH for transmission in the COT based on PSSCH messages it received earlier in the COT, within the execution environment of the COT sharing logic 704, the UE 115 identifies whether at least one such PSFCH is associated with the COT-initiating UE and would be transmitted within at least one of the RB sets making up the COT. The UE 115 may receive signals from or transmit signals to one or more neighboring UEs, such as UE 115b, or other network entities, such as the network entity 105 or the base station 140 of FIGS. 1-3.

The execution environment of the SL-U communication logic 701 and the SL feedback logic 703 enables the features and functionality for the UE 115 that support COT sharing and resuming based on PSFCHs in SL-U wideband operations according to one or more aspects. The execution environment of the SL-U communication logic 701 enables the UE 115 to perform sidelink communications over unlicensed spectrum using the wireless radios 700a-r and the antennas 252a-r. The UE 115, as a COT-initiating UE, may use resource configurations stored in the memory 282 at the SL resource configuration 702 in conjunction with the execution environment of the SL-U communication logic 701 in order to enable an SL-U wideband COT to conduct such SL-U communications. The SL-U communication may include transmissions, such as via PSSCH associated with neighboring UEs. The execution environment of the SL feedback logic 703 enables the UE 115, when acting as a COT-initiating UE, to identify feedback transmissions, such as PSFCHs, that are received from one or more neighboring UEs. For example, with one or more PSSCH transmitted from the UE 115 to at least one other neighboring UE, the UE 115, within the execution environment of the SL feedback logic 303, may expect to receive a PSFCH from those neighboring UEs.

The UE 115, when operating as a non-COT-initiating UE or responding UE, may also execute, via the processor 282, the SL-U communication logic 701, the SL feedback logic 703, which enables the UE 115, as a non-COT-initiating UE or responding UE, in conjunction with SL resource allocations, stored in the SL resource configuration 702 at the memory 282, to conduct sidelink communications over unlicensed spectrum using the wireless radios 700a-r and the antennas 252a-r. Within the execution environment of the SL-U communication logic 701, the UE 115 may expect to receive a COT-SI message that may identify the wideband SL-U bandwidth of a COT enabled by the COT-initiating UE. The COT-SI message may indicate whether or not the COT established by the COT-initiating can be shared. The UE 115, acting as the non-COT-initiating UE or responding UE, may further receive a PSSCH from another UE, including the COT-initiating UE, via the wireless radios 700a-r and the antennas 252a-r. Within the execution environments of the SL-U communication logic 701, the SL feedback logic 703, and the COT sharing logic 704, the UE 115, operating as a responding UE, may generate a feedback message for transmission of a PSFCH, identify whether the PSFCH symbols of the COT may be shared, and then share the COT by transmitting the PSFCH messages to the other UEs, including the COT-initiating UE via the wireless radios 700a-r and the antennas 252a-r.

Where the UE 115, as the COT-initiating UE, identifies that it wants to resume transmission within the COT, within the execution environments for the SL-U communication logic 701 and the SL feedback logic 703, the UE 115 may identify which RB sets of the plurality of RB sets of the SL-U wideband COT have been shared. Such identification may be made upon detecting which RB sets the UE 115 has received any PSFCHs on. Once the UE 115, as the COT-initiating UE, identifies the shared RB sets within the SL-U wideband COT, it may resume transmissions in available RBs of those shared RB sets using the wireless radios 700a-r and the antennas 252a-r.

It is noted that one or more blocks (or operations) described with reference to FIGS. 4A and 4B may be combined with one or more blocks (or operations) described with reference to another of the figures. For example, one or more blocks (or operations) of FIG. 4A may be combined with one or more blocks (or operations) of FIG. 5. As another example, one or more blocks associated with FIG. 4B may be combined with one or more blocks associated with FIG. 6B. As another example, one or more blocks associated with FIGS. 4A and 4B may be combined with one or more blocks (or operations) associated with FIGS. 1-3. Additionally, or alternatively, one or more operations described above with reference to FIGS. 1-3 may be combined with one or more operations described with reference to FIG. 7.

In one or more aspects, techniques for supporting COT sharing and resuming based on PSFCHs in SL-U wideband operations may include additional aspects, such as any single aspect or any combination of aspects described below or in connection with one or more other processes or devices described elsewhere herein. In a first aspect, supporting COT sharing and resuming based on PSFCHs in SL-U wideband operations may include an apparatus, such as a UE, capable of SL-U communications, configured to establish a COT having a wideband operational frequency associated with a plurality of RB sets and transmit a COT-SI message over a SL-U channel that includes a first indication enabling COT sharing with one or more neighboring UEs capable of SL-U communication and a second indication allowing transmission of PSFCHs. The UE may complete a first transmission within a portion of the COT, but then identify a second transmission to renew transmissions within the COT. The UE may identify one or more shared RB sets from the plurality of RB sets and transmit the second transmission using one or more available RBs within the one or more shared RB sets.

Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the at least one processor operable to cause the UE to identify the one or more shared RB sets is further operable to cause the UE to detect at least one PSFCH from at least one UE of the one or more neighboring UEs within the one or more shared RB sets.

In a third aspect, in combination with one or more of the first aspect or the second aspect, the COT-SI message further includes: a third indication identifying a required shared bandwidth of the COT which is required to be occupied by any neighboring UE of the one or more neighboring UEs, the required shared bandwidth including one of: a specified set of RB sets of the plurality of RB sets, or the wideband operational frequency.

In a fourth aspect, in combination with the third aspect, the at least one processor operable to cause the UE to transmit a sidelink control information (SCI) message including a priority indicator identifying a priority of a corresponding PSSCH of the one or more PSSCH associated with the UE transmission of the corresponding PSSCH, and transmit one or more physical sidelink shared channel (PSSCH) to at least one non-COT-initiating UEs of the one or more neighboring UEs.

In a fifth aspect, in combination with one or more of the first aspect through the fourth aspect, the at least one processor operable to cause the UE to elect to refrain from including the first indication in the COT-SI in response to a determination of no scheduled physical sidelink shared channel (PSSCH) being associated with the plurality of neighboring UEs within a plurality of PSSCH slots of the COT, and elect to include the first indication in the COT-SI in response to at least one of the scheduled PSSCH being associated with at least one neighboring UE of the plurality of neighboring UEs.

A sixth aspect may include an apparatus for wireless communication at a UE that includes at least one memory and at least one processor coupled with the at least one memory. The at least one processor is operable to cause the UE to receive a COT-SI message from a COT-initiating UE, the COT-SI including a first indication enabling COT sharing of a COT having a wideband operational frequency associated with a plurality of RB sets and a second indication allowing transmission of PSFCHs, identify at least one selected PSFCH of a plurality of selected PSFCHs for transmissions is within an RB of the plurality of RB sets and is associated with the COT-initiating UE, and transmit, over an SL-U channel, one or more selected PSFCHs of the plurality of selected PSFCHs in at least one RB set of the plurality of RB sets.

In a seventh aspect, in combination with the sixth aspect, the at least one processor operable to cause the UE to identify one or more RB sets of the plurality of RB sets in which at least one non-COT-initiating-UE-addressed PSFCH of the plurality of selected PSFCHs is located and none of the at least one selected PSFCH of the plurality of selected PSFCHs is located, and repeat transmission of a COT-initiating-UE-addressed PSFCH of the at least one selected PSFCH associated with the COT-initiating UE in each of the one or more RB sets.

In an eighth aspect, in combination with the seventh aspect, the at least one processor operable to cause the UE to identify at least two COT-initiating-UE-addressed PSFCH of the at least one selected PSFCH associated with the COT-initiating UE, and select the COT-initiating-UE-addressed PSFCH from the at least two COT-initiating-UE-addressed PSFCH according to an associated priority of a physical sidelink shared channel (PSSCH) corresponding to each of the at least two COT-initiating-UE-addressed PSFCH, the associated priority of the PSSCH corresponding to the COT-initiating-UE-addressed PSFCH being one of: a highest priority PSSCH or a lowest priority PSSCH.

In a ninth aspect, in combination with one or more of the seventh aspect through the eighth aspect, the at least one processor operable to cause the UE to, identify a plurality of scheduled PSFCHs over the plurality of RB sets including one or more COT-initiating-UE-addressed scheduled PSFCH corresponding to the at least one selected PSFCH associated with the COT-initiating UE and the COT-initiating-UE-addressed PSFCH in the each of the one or more RB sets, and select the plurality of selected PSFCHs from the plurality of scheduled PSFCH, a total number of the plurality of selected PSFCHs, N_{Tx,PSFCH}, being selected according to a number of scheduled PSFCHs, N_{sch,Tx,PSFCH}, in each RB set of the plurality of RB sets occupied by the one or more COT-initiating-UE-addressed scheduled PSFCH.

In a tenth aspect, in combination with one or more of the seventh aspect through the ninth aspect, the at least one processor operable to cause the UE to identify a plurality of scheduled PSFCHs for transmission in the COT, and select the plurality of selected PSFCHs to ensure at least one COT-initiating-UE-addressed PSFCH in each RB set of the plurality of RB sets occupied by a PSFCH transmission of the UE.

In an eleventh aspect, in combination with one or more of the sixth aspect through the tenth aspect, the COT-SI further includes a third indication identifying a required shared bandwidth of the COT which is required to be occupied by the UE upon sharing the COT, the required shared bandwidth including one or more required RB sets corresponding to one of: a pre-defined set of RB sets of the plurality of RB sets, or the wideband operational frequency.

In a twelfth aspect, in combination with the eleventh aspect, the at least one processor operable to cause the UE to receive a sidelink control information (SCI) message from the COT-initiating UE including a priority indicator identifying a priority of a corresponding PSSCH of one or more PSSCH associated with the UE, the priority being related to the COT-initiating UE transmission of the corresponding PSSCH, identify a highest priority between one or more PSFCH to be transmitted by the UE within the COT and one or more physical sidelink shared channel (PSSCH) to be transmitted by the UE within the COT, identify that the COT can be partially shared, in response to the one or more PSFCH being identified as having the highest priority, and occupy the required shared bandwidth for PSFCH transmissions, in response to the one or more PSSCH having the highest priority.

In a thirteenth aspect, in combination with one or more of the eleventh aspect through the twelfth aspect, the at least one processor operable to cause the UE to select the plurality of selected PSFCHs for transmission from a plurality of scheduled PSFCHs to include at least one required PSFCH for transmission within each required RB set of the required shared bandwidth and at least one COT-initiating-UE-addressed PSFCH in at least one shared RB of the plurality of RB sets of the COT.

In a fourteenth aspect, in combination with the thirteenth aspect, the at least one processor operable to cause the UE to select a number of the plurality of selected PSFCHs, N_{Tx,PSFCH}, to be ≥X≥1, where

$$X = max ( {\sum }_{i = 1}^{K} {M}_{i} , Y ) ,$$

K being a largest value that a total transmission power of all X of the plurality of selected PSFCHs is no larger than P_{CMAX}, Mᵢ being a determined number of PSFCHs having a priority value, i, and Y being a PSFCH index of a specific PSFCH, each selected PSFCH of the plurality of selected PSFCHs is indexed in an ascending order priority rule, the at least one processor operable to cause the UE to select the number of the plurality of selected PSFCHs, N_{Tx,PSFCH}, being executed in response to the total transmission power of the plurality of selected PSFCHs, P_{Tx,PSFCH}, being greater than P_{CMAX}, the number of the plurality of selected PSFCHs, N_{Tx,PSFCH}, being less than or equal to a maximum number of simultaneous PSFCHs, N_{max,PSFCH}, and an initial power value for a downlink pathloss-based power control for PSFCHs, dl-P0-PSFCH, being configured at the UE.

In a fifteenth aspect, in combination with the fourteenth aspect, the at least one processor operable to cause the UE to index each selected PSFCH of the plurality of selected PSFCHs according to one of: a time domain location, a frequency domain location, or a combination thereof of a physical sidelink shared channel (PSSCH) corresponding to the each selected PSFCH, the at least one processor operable to cause the UE to index each selected PSFCH of the plurality of selected PSFCHs being executed in response to two or more selected PSFCHs having a same priority under the ascending order priority rule.

In a sixteenth aspect, in combination with one or more of the fourteenth aspect through the fifteenth aspect, the specific PSFCH is identified as one of: a first selected PSFCH of the plurality of selected PSFCHs that ensures the at least one required PSFCH is transmitted within the each required RB set of the one or more required RB sets, or the first selected PSFCH of the plurality of selected PSFCHs that ensures the at least one required PSFCH is transmitted within the each required RB set of the required shared bandwidth and the at least one COT-initiating-UE-addressed PSFCH is transmitted within the at least one shared RB of the plurality of RB sets of the COT.

In a seventeenth aspect, in combination with one or more of the eleventh aspect through the sixteenth aspect, the at least one processor operable to cause the UE to select a number of the plurality of selected PSFCHs, N_{Tx,PSFCH}, to be ≥X≥1 up to a maximum number of simultaneous PSFCHs, N_{max,PSFCH}, where

$$X = max ( {\sum }_{i = 1}^{K} {M}_{i} Y ) ,$$

K being a largest value that a total transmission power of all X of the plurality of selected PSFCHs is no larger than P_{CMAX}, and Y being the PSFCH index of the specific PSFCH, and Y<the maximum number of simultaneous PSFCHs, N_{max,PSFCH}, otherwise

$$Y = {\sum }_{i = 1}^{K} {M}_{i} ,$$

the at least one processor operable to cause the UE to select the number of the plurality of selected PSFCHs, N_{Tx,PSFCH}, being executed in response to the number of the plurality of scheduled PSFCHs, N_{Tx,PSFCH}, exceeding the maximum number of simultaneous PSFCHs, N_{Tx,PSFCH}>N_{max,PSFCH}, and an initial power value for a downlink pathloss-based power control for PSFCHs, dl-P0-PSFCH, is configured at the UE.

In an eighteenth aspect, in combination with the seventeenth aspect, the at least one processor operable to cause the UE to select the plurality of selected PSFCHs according to the ascending order priority rule, the plurality of selected PSFCHs being selected to be ≥Y′≥1, Y′ being the PSFCH index of the specific PSFCH, the at least one processor operable to cause the UE to select the plurality of the selected PSFCHs according to the ascending order priority rule is executed in response to the dl-P0-PSFCH not being configured at the UE.

In a nineteenth aspect, in combination with one or more of the eleventh aspect through the eighteenth aspect, the at least one processor operable to cause the UE to select a number of the plurality of selected PSFCHs, N_{Tx,PSFCH}, PSFCHs according to a PSFCH selection sequence with N_{Tx,PSFCH}≥X≥1, with

$$X = max ( {\sum }_{i = 1}^{K} {M}_{i} , Y ) ,$$

the at least one processor operable to cause the UE to select the plurality of selected PSFCHs according to the PSFCH selection sequence being executed in response to a total transmission power of the plurality of scheduled PSFCHs, P_{sch,PSFCH}, being greater than a maximum transmission power, P_{CMAX}, the number of the plurality of scheduled PSFCHs, N_{sch,Tx,PSFCH}, being less than or equal to a maximum number of simultaneous PSFCHs, N_{max,PSFCH}, and an initial power value for a downlink pathloss-based power control for PSFCHs, dl-P0-PSFCH, being configured at the UE.

In a twentieth aspect, in combination with the nineteenth aspect, the PSFCH selection sequence includes the at least one processor operable to cause the UE to: select a first set of selected PSFCHs, on a per RB basis of the one or more required RB sets, from the plurality of scheduled PSFCHs, each PSFCH of the first set of selected PSFCHs being associated with one of: a lowest priority according to an ascending order priority rule or an earliest slot; and select a next set of selected PSFCHs over remaining scheduled PSFCHs of the plurality of scheduled PSFCHs according to the ascending order priority rule for hybrid automatic repeat request-acknowledgement (HARQ-ACK)-information-containing PSFCHs of the remaining scheduled PSFCHs first and then conflict-information-containing PSFCHs of the remaining scheduled PSFCHs.

In a twenty-first aspect, in combination with one or more of the nineteenth aspect through the twentieth aspect, the PSFCH selection sequence includes the at least one processor operable to cause the UE to: select a first set of selected PSFCHs from one or more COT-initiating-UE-associated PSFCHs of the plurality of scheduled PSFCHs associated with one of: a lowest priority according to an ascending order priority rule or an earliest slot; select a second set of selected PSFCHs from remaining scheduled PSFCHs of the plurality of scheduled PSFCHs in one or more non-COT-initiating-UE-associated RB sets of the one or more required RB sets that have no PSFCH associated with the COT-initiating UE, each PSFCH of the second set of selected PSFCHs being associated with one of: a lowest priority according to the ascending order priority rule or an earliest slot; and select a third set of selected PSFCHs from the remaining scheduled PSFCHs of the plurality of scheduled PSFCHs according to the ascending order priority rule for hybrid automatic repeat request-acknowledgement (HARQ-ACK)-information-containing PSFCHs of the remaining scheduled PSFCHs first and then conflict-information-containing PSFCHs of the remaining scheduled PSFCHs.

In a twenty-second aspect, in combination with one or more of the eleventh aspect through the twenty-first aspect, the at least one processor operable to cause the UE to select a number of the plurality of selected PSFCHs, N_{Tx,PSFCH}, from a maximum number of simultaneous PSFCHs, N_{max,PSFCH}, according to a PSFCH selection sequence in response to a number of scheduled PSFCHs, N_{sch,Tx,PSFCH}, being greater than the maximum number of simultaneous PSFCHs, N_{sch,Tx,PSFCH}>N_{max,PSFCH} and an initial power value for a downlink pathloss-based power control for PSFCHs, dl-P0-PSFCH, being configured, the PSFCH selection sequence including the at least one processor operable to cause the UE to select the plurality of selected PSFCHs from the maximum number of simultaneous PSFCHs, N_{max,PSFCH}, according to one of the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCH, or to ensure at least one COT-initiating-UE-addressed PSFCH of the N_{Tx,PSFCH} PSFCHs is transmitted in each RB set of the plurality of RB sets occupied by a PSFCH transmission of the UE, where the number of the plurality of selected PSFCHs, N_{Tx,PSFCH}≥X≥1, and

$$X = max ( {\sum }_{i = 1}^{K} {M}_{i} ) ,$$

the at least one processor operable to cause the UE to select the plurality of selected PSFCHs according to one of: the ascending order priority rule of the plurality of scheduled PSFCHs or to ensure the at least one COT-initiating-UE-addressed PSFCH is transmitted in the each RB set occupied by the PSFCH transmission of the UE being executed in response to the total transmission power of the plurality of scheduled PSFCHs, P_{sch,Tx,PSFCH}, being greater than a maximum transmission power, P_{CMAX}, the number of the plurality of scheduled PSFCHs, N_{sch,Tx,PSFCH}, being less than or equal to the maximum number of simultaneous PSFCHs, N_{max,PSFCH}, and the dl-P0-PSFCH being configured at the UE.

In a twenty-third aspect, in combination with one or more of the eleventh aspect through the twenty-second aspect, the at least one processor operable to cause the UE to select the plurality of selected PSFCHs from the maximum number of simultaneous PSFCHs, N_{max,PSFCH}, according to one of the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCH, or to ensure at least one COT-initiating-UE-addressed PSFCH of the N_{Tx,PSFCH} PSFCHs is transmitted in each RB set of the plurality of RB sets occupied by a PSFCH transmission of the UE, where the number of the plurality of selected PSFCHs, N_{Tx,PSFCH}≥X≥1, and

$$X = max ( {\sum }_{i = 1}^{K} {M}_{i} )$$

and a total transmission power of the plurality of selected PSFCHs, P_{Tx,PSFCH}, is less than or equal to a maximum transmission power, P_{CMAX}, the at least one processor operable to cause the UE to select the plurality of selected PSFCHs according to one of: the ascending order priority rule of the plurality of scheduled PSFCHs or to ensure the at least one COT-initiating-UE-addressed PSFCH being transmitted in each RB set occupied by the PSFCH transmission of the UE being executed in response to a downlink pathloss-based power control for PSFCHs, dl-P0-PSFCH, not being configured at the UE.

A twenty-fourth aspect for wireless communication performed by a UE may include establishing a COT having a wideband operational frequency associated with a plurality of RB sets, transmitting a COT-SI message over a SL-U channel that includes a first indication enabling COT sharing with one or more neighboring UEs capable of SL-U communication and a second indication allowing transmission of PSFCHs, completing a first transmission within a portion of the COT, identifying a second transmission to renew transmissions within the COT, identifying one or more shared RB sets from the plurality of RB sets, and transmitting the second transmission using one or more available RBs within the one or more shared RB sets.

In a twenty-fifth aspect, in combination with the twenty-fourth aspect, the identifying the one or more shared RB sets further includes detecting at least one PSFCH from at least one UE of the one or more neighboring UEs within the one or more shared RB sets.

In a twenty-sixth aspect, in combination with one or more of the twenty-fourth aspect through the twenty-fifth aspect, the COT-SI message further includes a third indication identifying a required shared bandwidth of the COT which is required to be occupied by any neighboring UE of the one or more neighboring UEs, the required shared bandwidth including one of: a specified set of RB sets of the plurality of RB sets, or the wideband operational frequency.

In a twenty-seventh aspect, in combination with the twenty-sixth aspect, transmitting a sidelink control information (SCI) message including a priority indicator identifying a priority of a corresponding PSSCH of the one or more PSSCH associated with the UE transmission of the corresponding PSSCH. And transmitting one or more physical sidelink shared channel (PSSCH) to at least one non-COT-initiating UEs of the one or more neighboring UEs.

In a twenty-eighth aspect, in combination with one or more of the twenty-fourth aspect through the twenty-seventh aspect, electing to refrain from including the first indication in the COT-SI in response to a determination of no scheduled physical sidelink shared channel (PSSCH) being associated with the plurality of neighboring UEs within a plurality of PSSCH slots of the COT, and electing to include the first indication in the COT-SI in response to at least one of the scheduled PSSCH being associated with at least one neighboring UE of the plurality of neighboring UEs.

A twenty-ninth aspect for wireless communication performed by a UE may include receiving a COT-SI message from a COT-initiating UE, the COT-SI including a first indication enabling COT sharing of a COT having a wideband operational frequency associated with a plurality of RB sets and a second indication allowing transmission of PSFCHs, identifying at least one selected PSFCH of a plurality of selected PSFCHs for transmissions is within an RB of the plurality of RB sets and is associated with the COT-initiating UE, and transmitting, over an SL-U channel, one or more selected PSFCHs of the plurality of selected PSFCHs in at least one RB set of the plurality of RB sets.

In a thirtieth aspect, in combination with the twenty-ninth aspect, identifying one or more RB sets of the plurality of RB sets in which at least one non-COT-initiating-UE-addressed PSFCH of the plurality of selected PSFCHs is located and none of the at least one selected PSFCH of the plurality of selected PSFCHs is located, and repeating transmission of a COT-initiating-UE-addressed PSFCH of the at least one selected PSFCH associated with the COT-initiating UE in each of the one or more RB sets.

In a thirty-first aspect, in combination with the thirtieth aspect, identifying at least two COT-initiating-UE-addressed PSFCH of the at least one selected PSFCH associated with the COT-initiating UE; and selecting the COT-initiating-UE-addressed PSFCH from the at least two COT-initiating-UE-addressed PSFCH according to an associated priority of a physical sidelink shared channel (PSSCH) corresponding to each of the at least two COT-initiating-UE-addressed PSFCH, the associated priority of the PSSCH corresponding to the COT-initiating-UE-addressed PSFCH being one of: a highest priority PSSCH or a lowest priority PSSCH.

In a thirty-second aspect, in combination with one or more of the thirtieth aspect through the thirty-first aspect, identifying a plurality of scheduled PSFCHs over the plurality of RB sets including one or more COT-initiating-UE-addressed scheduled PSFCH corresponding to the at least one selected PSFCH associated with the COT-initiating UE and the COT-initiating-UE-addressed PSFCH in the each of the one or more RB sets, and selecting the plurality of selected PSFCHs from the plurality of scheduled PSFCH, a total number of the plurality of selected PSFCHs, N_{Tx,PSFCH}, being selected according to a number of scheduled PSFCHs, N_{sch,Tx,PSFCH}, in each RB set of the plurality of RB sets occupied by the one or more COT-initiating-UE-addressed scheduled PSFCH.

In a thirty-third aspect, in combination with one or more of the thirtieth aspect through the thirty-second aspect, identifying a plurality of scheduled PSFCHs for transmission in the COT, and selecting the plurality of selected PSFCHs to ensure at least one COT-initiating-UE-addressed PSFCH in each RB set of the plurality of RB sets occupied by a PSFCH transmission of the UE.

In a thirty-fourth aspect, in combination with one or more of the twenty-ninth aspect through the thirty-fourth aspect, the COT-SI further includes a third indication identifying a required shared bandwidth of the COT which is required to be occupied by the UE upon sharing the COT, the required shared bandwidth including one or more required RB sets corresponding to one of: a pre-defined set of RB sets of the plurality of RB sets, or the wideband operational frequency.

In a thirty-fifth aspect, in combination with thirty-fourth aspect, receiving a sidelink control information (SCI) message from the COT-initiating UE including a priority indicator identifying a priority of a corresponding PSSCH of one or more PSSCH associated with the UE, the priority being related to the COT-initiating UE transmission of the corresponding PSSCH, identifying a highest priority between one or more PSFCH to be transmitted by the UE within the COT and one or more physical sidelink shared channel (PSSCH) to be transmitted by the UE within the COT, identifying that the COT can be partially shared, in response to the one or more PSFCH being identified as having the highest priority, and occupying the required shared bandwidth for PSFCH transmissions, in response to the one or more PSSCH having the highest priority.

In a thirty-sixth aspect, in combination with one or more of the thirty-fourth aspect through the thirty-fifth aspect, selecting the plurality of selected PSFCHs for transmission from a plurality of scheduled PSFCHs to include at least one required PSFCH for transmission within each required RB set of the required shared bandwidth and at least one COT-initiating-UE-addressed PSFCH in at least one shared RB of the plurality of RB sets of the COT.

In a thirty-seventh aspect, in combination with one or more of the thirty-sixth aspect through the thirty-sixth aspect, selecting a number of the plurality of selected PSFCHs, N_{Tx,PSFCH}, to be ≥X≥1, where

$$X = max ( {\sum }_{i = 1}^{K} {M}_{i} , Y ) ,$$

K being a largest value that a total transmission power of all X of the plurality of selected PSFCHs is no larger than P_{CMAX}, Mᵢ being a determined number of PSFCHs having a priority value, i, and Y being a PSFCH index of a specific PSFCH, each selected PSFCH of the plurality of selected PSFCHs is indexed in an ascending order priority rule, the selecting the number of the plurality of selected PSFCHs, N_{Tx,PSFCH}, being in response to the total transmission power of the plurality of selected PSFCHs, P_{Tx,PSFCH}, being greater than P_{CMAX}, the number of the plurality of selected PSFCHs, N_{Tx,PSFCH}, being less than or equal to a maximum number of simultaneous PSFCHs, N_{max,PSFCH}, and an initial power value for a downlink pathloss-based power control for PSFCHs, dl-P0-PSFCH, being configured at the UE.

In a thirty-eighth aspect, in combination with the thirty-seventh aspect, including indexing each selected PSFCH of the plurality of selected PSFCHs according to one of: a time domain location, a frequency domain location, or a combination thereof of a physical sidelink shared channel (PSSCH) corresponding to the each selected PSFCH, the indexing each selected PSFCH of the plurality of selected PSFCHs being performed in response to two or more selected PSFCHs having a same priority under the ascending order priority rule.

In a thirty-ninth aspect, in combination with one or more of the thirty-seventh aspect through the thirty-eighth aspect, the specific PSFCH is identified as one of a first selected PSFCH of the plurality of selected PSFCHs that ensures the at least one required PSFCH is transmitted within the each required RB set of the one or more required RB sets, or the first selected PSFCH of the plurality of selected PSFCHs that ensures the at least one required PSFCH is transmitted within the each required RB set of the required shared bandwidth and the at least one COT-initiating-UE-addressed PSFCH is transmitted within the at least one shared RB of the plurality of RB sets of the COT.

In a fortieth aspect, in combination with one or more of the thirty-fourth aspect through the thirty-ninth aspect, selecting a number of the plurality of selected PSFCHs, N_{Tx,PSFCH}, to be ≥X≥1 up to a maximum number of simultaneous PSFCHs, N_{max,PSFCH}, where

$$X = max ( {\sum }_{i = 1}^{K} {M}_{i} Y ) ,$$

K being a largest value that a total transmission power of all X of the plurality of selected PSFCHs is no larger than P_{CMAX}, and Y being the PSFCH index of the specific PSFCH, and Y<the maximum number of simultaneous PSFCHs, N_{max,PSFCH}, otherwise

$$Y = {\sum }_{i = 1}^{K} {M}_{i} ,$$

the selecting the number of the plurality of selected PSFCHs, N_{Tx,PSFCH}, being performed in response to the number of the plurality of scheduled PSFCHs, N_{Tx,PSFCH}, exceeding the maximum number of simultaneous PSFCHs, N_{Tx,PSFCH}>N_{max,PSFCH}, and an initial power value for a downlink pathloss-based power control for PSFCHs, dl-P0-PSFCH, is configured at the UE.

In a forty-first aspect, in combination with the fortieth aspect, selecting the plurality of selected PSFCHs according to the ascending order priority rule, the plurality of selected PSFCHs being selected to be ≥Y′≥1, Y′ being the PSFCH index of the specific PSFCH, the selecting the plurality of the selected PSFCHs according to the ascending order priority rule being performed in response to the dl-P0-PSFCH not being configured at the UE.

In a forty-second aspect, in combination with one or more of the thirty-fourth aspect through the forty-first aspect, selecting a number of the plurality of selected PSFCHs, N_{Tx,PSFCH}, PSFCHs according to a PSFCH selection sequence with N_{Tx,PSFCH}≥X≥1, with

$$X = max ( {\sum }_{i = 1}^{K} {M}_{i} , Y ) ,$$

the selecting the plurality of selected PSFCHs according to the PSFCH selection sequence being performed in response to a total transmission power of the plurality of scheduled PSFCHs, P_{sch,PSFCH}, being greater than a maximum transmission power, P_{CMAX}, the number of the plurality of scheduled PSFCHs, N_{sch,Tx,PSFCH}, being less than or equal to a maximum number of simultaneous PSFCHs, N_{max,PSFCH}, and an initial power value for a downlink pathloss-based power control for PSFCHs, dl-P0-PSFCH, being configured at the UE.

In a forty-third aspect, in combination with the forty-second aspect, the PSFCH selection sequence includes selecting a first set of selected PSFCHs, on a per RB basis of the one or more required RB sets, from the plurality of scheduled PSFCHs, each PSFCH of the first set of selected PSFCHs being associated with one of: a lowest priority according to an ascending order priority rule or an earliest slot, and selecting a next set of selected PSFCHs over remaining scheduled PSFCHs of the plurality of scheduled PSFCHs according to the ascending order priority rule for hybrid automatic repeat request-acknowledgement (HARQ-ACK)-information-containing PSFCHs of the remaining scheduled PSFCHs first and then conflict-information-containing PSFCHs of the remaining scheduled PSFCHs.

In a forty-fourth aspect, in combination with one or more of the forty-second aspect through the forty-third aspect, the PSFCH selection sequence includes selecting a first set of selected PSFCHs from one or more COT-initiating-UE-associated PSFCHs of the plurality of scheduled PSFCHs associated with one of: a lowest priority according to an ascending order priority rule or an earliest slot, selecting a second set of selected PSFCHs from remaining scheduled PSFCHs of the plurality of scheduled PSFCHs in one or more non-COT-initiating-UE-associated RB sets of the one or more required RB sets that have no PSFCH associated with the COT-initiating UE, each PSFCH of the second set of selected PSFCHs being associated with one of: a lowest priority according to the ascending order priority rule or an earliest slot, and selecting a third set of selected PSFCHs from the remaining scheduled PSFCHs of the plurality of scheduled PSFCHs according to the ascending order priority rule for hybrid automatic repeat request-acknowledgement (HARQ-ACK)-information-containing PSFCHs of the remaining scheduled PSFCHs first and then conflict-information-containing PSFCHs of the remaining scheduled PSFCHs.

In a forty-fifth aspect, in combination with one or more of the thirty-fourth aspect through the forty-fourth aspect, selecting a number of the plurality of selected PSFCHs, N_{Tx,PSFCH}, from a maximum number of simultaneous PSFCHs, N_{max,PSFCH}, according to a PSFCH selection sequence in response to a number of scheduled PSFCHs, N_{sch,Tx,PSFCH}, being greater than the maximum number of simultaneous PSFCHs, N_{sch,Tx,PSFCH}>N_{max,PSFCH} and an initial power value for a downlink pathloss-based power control for PSFCHs, dl-P0-PSFCH, being configured, the PSFCH selection sequence including selecting the plurality of selected PSFCHs from the maximum number of simultaneous PSFCHs, N_{max,PSFCH}, according to one of the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCH, or to ensure at least one COT-initiating-UE-addressed PSFCH of the N_{Tx,PSFCH} PSFCHs is transmitted in each RB set of the plurality of RB sets occupied by a PSFCH transmission of the UE, where the number of the plurality of selected PSFCHs, N_{Tx,PSFCH}≥X≥1, and

$$X = max ( {\sum }_{i = 1}^{K} {M}_{i} ) ,$$

the selecting the plurality of selected PSFCHs according to one of: the ascending order priority rule of the plurality of scheduled PSFCHs or to ensure the at least one COT-initiating-UE-addressed PSFCH is transmitted in the each RB set occupied by the PSFCH transmission of the UE being performed in response to the total transmission power of the plurality of scheduled PSFCHs, P_{sch,Tx,PSFCH}, being greater than a maximum transmission power, P_{CMAX}, the number of the plurality of scheduled PSFCHs, N_{sch,Tx,PSFCH}, being less than or equal to the maximum number of simultaneous PSFCHs, N_{max,PSFCH}, and the dl-P0-PSFCH being configured at the UE.

In a forty-sixth aspect, in combination with one or more of the thirty-fourth aspect through the forty-fifth aspect, selecting the plurality of selected PSFCHs from the maximum number of simultaneous PSFCHs, N_{max,PSFCH}, according to one of the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCH, or to ensure at least one COT-initiating-UE-addressed PSFCH of the N_{Tx,PSFCH} PSFCHs is transmitted in each RB set of the plurality of RB sets occupied by a PSFCH transmission of the UE, where the number of the plurality of selected PSFCHs, N_{Tx,PSFCH}≥X≥1, and

$$X = max ( {\sum }_{i = 1}^{K} {M}_{i} )$$

and a total transmission power of the plurality of selected PSFCHs, P_{Tx,PSFCH}, is less than or equal to a maximum transmission power, P_{CMAX}, the selecting the plurality of selected PSFCHs according to one of: the ascending order priority rule of the plurality of scheduled PSFCHs or to ensure the at least one COT-initiating-UE-addressed PSFCH being transmitted in each RB set occupied by the PSFCH transmission of the UE being performed in response to a downlink pathloss-based power control for PSFCHs, dl-P0-PSFCH, not being configured at the UE.

A forty-seventh aspect for wireless communication by a UE may include means for establishing a COT having a wideband operational frequency associated with a plurality of RB sets, transmitting over an SL-U channel a COT-SI message that includes a first indication enabling COT sharing with one or more neighboring UEs capable of SL-U communication and a second indication allowing transmission of PSFCHs, means for completing a first transmission within a portion of the COT, means for identifying a second transmission to renew transmissions within the COT, means for identifying one or more shared RB sets from the plurality of RB sets, and means for transmitting the second transmission using one or more available RBs within the one or more shared RB sets.

In a forty-eighth aspect, in combination with the forty-seventh aspect, the means for identifying the one or more shared RB sets further includes means for detecting at least one PSFCH from at least one UE of the one or more neighboring UEs within the one or more shared RB sets.

In a forty-ninth aspect, in combination with one or more of the forty-seventh aspect through the forty-eighth aspect, the COT-SI message further includes a third indication identifying a required shared bandwidth of the COT which is required to be occupied by any neighboring UE of the one or more neighboring UEs, the required shared bandwidth including one of: a specified set of RB sets of the plurality of RB sets, or the wideband operational frequency.

In a fiftieth aspect, in combination with the forty-ninth aspect, means for transmitting a sidelink control information (SCI) message including a priority indicator identifying a priority of a corresponding PSSCH of the one or more PSSCH associated with the UE transmission of the corresponding PSSCH, and means for transmitting one or more physical sidelink shared channel (PSSCH) to at least one non-COT-initiating UEs of the one or more neighboring UEs.

In a fifty-first aspect, in combination with one or more of the forty-seventh aspect through the fiftieth aspect, means for electing to refrain from including the first indication in the COT-SI in response to a determination of no scheduled physical sidelink shared channel (PSSCH) being associated with the plurality of neighboring UEs within a plurality of PSSCH slots of the COT, and means for electing to include the first indication in the COT-SI in response to at least one of the scheduled PSSCH being associated with at least one neighboring UE of the plurality of neighboring UEs.

A fifty-second aspect for wireless communication by a UE may include means for receiving a COT-SI message from a COT-initiating UE, the COT-SI including a first indication enabling COT sharing of a COT having a wideband operational frequency associated with a plurality of RB sets and a second indication allowing transmission of PSFCHs, means for identifying at least one selected PSFCH of a plurality of selected PSFCHs for transmissions is within an RB of the plurality of RB sets and is associated with the COT-initiating UE, and means for transmitting, over an SL-U channel, one or more selected PSFCHs of the plurality of selected PSFCHs in at least one RB set of the plurality of RB sets.

In a fifty-third aspect, in combination with fifty-second aspect, means for identifying one or more RB sets of the plurality of RB sets in which at least one non-COT-initiating-UE-addressed PSFCH of the plurality of selected PSFCHs is located and none of the at least one selected PSFCH of the plurality of selected PSFCHs is located, and means for repeating transmission of a COT-initiating-UE-addressed PSFCH of the at least one selected PSFCH associated with the COT-initiating UE in each of the one or more RB sets.

In a fifty-fourth aspect, in combination with the fifty-third aspect, means for identifying at least two COT-initiating-UE-addressed PSFCH of the at least one selected PSFCH associated with the COT-initiating UE, and means for selecting the COT-initiating-UE-addressed PSFCH from the at least two COT-initiating-UE-addressed PSFCH according to an associated priority of a physical sidelink shared channel (PSSCH) corresponding to each of the at least two COT-initiating-UE-addressed PSFCH, the associated priority of the PSSCH corresponding to the COT-initiating-UE-addressed PSFCH being one of: a highest priority PSSCH or a lowest priority PSSCH.

In a fifty-fifth aspect, in combination with one or more of the fifty-third aspect through the fifty-fourth aspect, means for identifying a plurality of scheduled PSFCHs over the plurality of RB sets including one or more COT-initiating-UE-addressed scheduled PSFCH corresponding to the at least one selected PSFCH associated with the COT-initiating UE and the COT-initiating-UE-addressed PSFCH in the each of the one or more RB sets, and means for selecting the plurality of selected PSFCHs from the plurality of scheduled PSFCH, a total number of the plurality of selected PSFCHs, N_{Tx,PSFCH}, being selected according to a number of scheduled PSFCHs, N_{sch,Tx,PSFCH}, in each RB set of the plurality of RB sets occupied by the one or more COT-initiating-UE-addressed scheduled PSFCH.

In a fifty-sixth aspect, in combination with one or more of the fifty-third aspect through the fifty-fifth aspect, means for identifying a plurality of scheduled PSFCHs for transmission in the COT, and means for selecting the plurality of selected PSFCHs to ensure at least one COT-initiating-UE-addressed PSFCH in each RB set of the plurality of RB sets occupied by a PSFCH transmission of the UE.

In a fifty-seventh aspect, in combination with one or more of the fifty-second aspect through the fifty-sixth aspect, the COT-SI further includes a third indication identifying a required shared bandwidth of the COT which is required to be occupied by the UE upon sharing the COT, the required shared bandwidth including one or more required RB sets corresponding to one of: a pre-defined set of RB sets of the plurality of RB sets, or the wideband operational frequency.

In a fifty-eighth aspect, in combination with the fifty-seventh aspect, means for receiving a sidelink control information (SCI) message from the COT-initiating UE including a priority indicator identifying a priority of a corresponding PSSCH of one or more PSSCH associated with the UE, the priority being related to the COT-initiating UE transmission of the corresponding PSSCH; means for identifying a highest priority between one or more PSFCH to be transmitted by the UE within the COT and one or more physical sidelink shared channel (PSSCH) to be transmitted by the UE within the COT, means for identifying that the COT can be partially shared, in response to the one or more PSFCH being identified as having the highest priority, and means for occupying the required shared bandwidth for PSFCH transmissions, in response to the one or more PSSCH having the highest priority.

In a fifty-ninth aspect, in combination with one or more of the fifty-seventh aspect through the fifty-eighth aspect, means for selecting the plurality of selected PSFCHs for transmission from a plurality of scheduled PSFCHs to include at least one required PSFCH for transmission within each required RB set of the required shared bandwidth and at least one COT-initiating-UE-addressed PSFCH in at least one shared RB of the plurality of RB sets of the COT.

In a sixtieth aspect, in combination with the fifty-ninth aspect, means for selecting a number of the plurality of selected PSFCHs, N_{Tx,PSFCH}, to be ≥X≥1, where

$$X = max ( {\sum }_{i = 1}^{K} {M}_{i} , Y ) ,$$

K being a largest value that a total transmission power of all X of the plurality of selected PSFCHs is no larger than P_{CMAX}, Mᵢ being a determined number of PSFCHs having a priority value, i, and Y being a PSFCH index of a specific PSFCH, each selected PSFCH of the plurality of selected PSFCHs is indexed in an ascending order priority rule, the means for selecting the number of the plurality of selected PSFCHs, N_{Tx,PSFCH}, being executed in response to the total transmission power of the plurality of selected PSFCHs, P_{Tx,PSFCH}, being greater than P_{CMAX}, the number of the plurality of selected PSFCHs, N_{Tx,PSFCH}, being less than or equal to a maximum number of simultaneous PSFCHs, N_{max,PSFCH}, and an initial power value for a downlink pathloss-based power control for PSFCHs, dl-P0-PSFCH, being configured at the UE.

In a sixty-first aspect, in combination with the sixtieth aspect, means for indexing each selected PSFCH of the plurality of selected PSFCHs according to one of: a time domain location, a frequency domain location, or a combination thereof of a physical sidelink shared channel (PSSCH) corresponding to the each selected PSFCH, the means for indexing each selected PSFCH of the plurality of selected PSFCHs being executed in response to two or more selected PSFCHs having a same priority under the ascending order priority rule.

In a sixty-second aspect, in combination with one or more of the sixieth aspect through the sixty-first aspect, the specific PSFCH is identified as one of a first selected PSFCH of the plurality of selected PSFCHs that ensures the at least one required PSFCH is transmitted within the each required RB set of the one or more required RB sets, or the first selected PSFCH of the plurality of selected PSFCHs that ensures the at least one required PSFCH is transmitted within the each required RB set of the required shared bandwidth and the at least one COT-initiating-UE-addressed PSFCH is transmitted within the at least one shared RB of the plurality of RB sets of the COT.

In a sixty-third aspect, in combination with one or more of the fifty-seventh aspect through the sixty-second aspect, means for selecting a number of the plurality of selected PSFCHs, N_{Tx,PSFCH}, to be ≥X≥1 up to a maximum number of simultaneous PSFCHs, N_{max,PSFCH}, where

$$X = max ( {\sum }_{i = 1}^{K} {M}_{i} Y ) ,$$

K being a largest value that a total transmission power of all X of the plurality of selected PSFCHs is no larger than P_{CMAX}, and Y being the PSFCH index of the specific PSFCH, and Y<the maximum number of simultaneous PSFCHs, N_{max,PSFCH}, otherwise

$$Y = {\sum }_{i = 1}^{K} {M}_{i} ,$$

the means for selecting the number of the plurality of selected PSFCHs, N_{Tx,PSFCH}, being executed in response to the number of the plurality of scheduled PSFCHs, N_{Tx,PSFCH}, exceeding the maximum number of simultaneous PSFCHs, N_{Tx,PSFCH}>N_{max,PSFCH}, and an initial power value for a downlink pathloss-based power control for PSFCHs, dl-P0-PSFCH, is configured at the UE.

In a sixty-fourth aspect, in combination with the sixty-third aspect, means for selecting the plurality of selected PSFCHs according to the ascending order priority rule, the plurality of selected PSFCHs being selected to be ≥Y′≥1, Y′ being the PSFCH index of the specific PSFCH, the means for selecting the plurality of the selected PSFCHs according to the ascending order priority rule being executed in response to the dl-P0-PSFCH not being configured at the UE.

In a sixty-fifth aspect, in combination with one or more of the fifty-seventh aspect through the sixty-fourth aspect, means for selecting a number of the plurality of selected PSFCHs, N_{Tx,PSFCH}, PSFCHs according to a PSFCH selection sequence with N_{Tx,PSFCH}≥X≥1, with

$$X = max ( {\sum }_{i = 1}^{K} {M}_{i} , Y ) ,$$

the means for selecting the plurality of selected PSFCHs according to the PSFCH selection sequence being executed in response to a total transmission power of the plurality of scheduled PSFCHs, P_{sch,PSFCH}, being greater than a maximum transmission power, P_{CMAX}, the number of the plurality of scheduled PSFCHs, N_{sch,Tx,PSFCH}, being less than or equal to a maximum number of simultaneous PSFCHs, N_{max,PSFCH}, and an initial power value for a downlink pathloss-based power control for PSFCHs, dl-P0-PSFCH, being configured at the UE.

In a sixty-sixth aspect, in combination with the sixty-fifth aspect, the PSFCH selection sequence includes means for selecting a first set of selected PSFCHs, on a per RB basis of the one or more required RB sets, from the plurality of scheduled PSFCHs, each PSFCH of the first set of selected PSFCHs being associated with one of: a lowest priority according to an ascending order priority rule or an earliest slot, and means for selecting a next set of selected PSFCHs over remaining scheduled PSFCHs of the plurality of scheduled PSFCHs according to the ascending order priority rule for hybrid automatic repeat request-acknowledgement (HARQ-ACK)-information-containing PSFCHs of the remaining scheduled PSFCHs first and then conflict-information-containing PSFCHs of the remaining scheduled PSFCHs.

In a sixty-seventh aspect, in combination with one or more of the sixty-fifth aspect through the sixty-sixth aspect, the PSFCH selection sequence includes means for selecting a first set of selected PSFCHs from one or more COT-initiating-UE-associated PSFCHs of the plurality of scheduled PSFCHs associated with one of: a lowest priority according to an ascending order priority rule or an earliest slot, means for selecting a second set of selected PSFCHs from remaining scheduled PSFCHs of the plurality of scheduled PSFCHs in one or more non-COT-initiating-UE-asscoated RB sets of the one or more required RB sets that have no PSFCH associated with the COT-initiating UE, each PSFCH of the second set of selected PSFCHs being associated with one of: a lowest priority according to the ascending order priority rule or an earliest slot, and means for selecting a third set of selected PSFCHs from the remaining scheduled PSFCHs of the plurality of scheduled PSFCHs according to the ascending order priority rule for hybrid automatic repeat request-acknowledgement (HARQ-ACK)-information-containing PSFCHs of the remaining scheduled PSFCHs first and then conflict-information-containing PSFCHs of the remaining scheduled PSFCHs.

In a sixty-eighth aspect, in combination with one or more of the fifty-seventh aspect through the sixty-seventh aspect, means for selecting a number of the plurality of selected PSFCHs, N_{Tx,PSFCH}, from a maximum number of simultaneous PSFCHs, N_{max,PSFCH}, according to a PSFCH selection sequence in response to a number of scheduled PSFCHs, N_{sch,Tx,PSFCH}, being greater than the maximum number of simultaneous PSFCHs, N_{sch,Tx,PSFCH}>N_{max,PSFCH} and an initial power value for a downlink pathloss-based power control for PSFCHs, dl-P0-PSFCH, being configured, the PSFCH selection sequence including means for selecting the plurality of selected PSFCHs from the maximum number of simultaneous PSFCHs, N_{max,PSFCH}, according to one of the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCH, or to ensure at least one COT-initiating-UE-addressed PSFCH of the N_{Tx,PSFCH} PSFCHs is transmitted in each RB set of the plurality of RB sets occupied by a PSFCH transmission of the UE, where the number of the plurality of selected PSFCHs, N_{Tx,PSFCH}≥X≥1, and

$$X = max ( {\sum }_{i = 1}^{K} {M}_{i} ) ,$$

the means for selecting the plurality of selected PSFCHs according to one of: the ascending order priority rule of the plurality of scheduled PSFCHs or to ensure the at least one COT-initiating-UE-addressed PSFCH is transmitted in the each RB set occupied by the PSFCH transmission of the UE being executed in response to the total transmission power of the plurality of scheduled PSFCHs, P_{sch,Tx,PSFCH}, being greater than a maximum transmission power, P_{CMAX}, the number of the plurality of scheduled PSFCHs, N_{sch,Tx,PSFCH}, being less than or equal to the maximum number of simultaneous PSFCHs, N_{max,PSFCH}, and the dl-P0-PSFCH being configured at the UE.

In a sixty-ninth aspect, in combination with one or more of the fifty-seventh aspect through the sixty-eighth aspect, means for selecting the plurality of selected PSFCHs from the maximum number of simultaneous PSFCHs, N_{max,PSFCH}, according to one of the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCH, or to ensure at least one COT-initiating-UE-addressed PSFCH of the N_{Tx,PSFCH} PSFCHs is transmitted in each RB set of the plurality of RB sets occupied by a PSFCH transmission of the UE, where the number of the plurality of selected PSFCHs, N_{Tx,PSFCH}≥X≥1, and

$$X = max ( {\sum }_{i = 1}^{K} {M}_{i} )$$

and a total transmission power of the plurality of selected PSFCHs, P_{Tx,PSFCH}, is less than or equal to a maximum transmission power, P_{CMAX}, the means for selecting the plurality of selected PSFCHs according to one of: the ascending order priority rule of the plurality of scheduled PSFCHs or to ensure the at least one COT-initiating-UE-addressed PSFCH being transmitted in each RB set occupied by the PSFCH transmission of the UE being executed in response to a downlink pathloss-based power control for PSFCHs, dl-P0-PSFCH, not being configured at the UE.

A seventieth aspect includes a non-transitory computer-readable medium storing instructions on a UE. When executed by a processor, the instructions cause the processor to perform operations including establishing a COT having a wideband operational frequency associated with a plurality of RB sets, transmitting over an SL-U channel a COT-SI message that includes a first indication enabling COT sharing with one or more neighboring UEs capable of SL-U communication and a second indication allowing transmission of PSFCHs, completing a first transmission within a portion of the COT, identifying a second transmission to renew transmissions within the COT, identifying one or more shared RB sets from the plurality of RB sets, and transmitting the second transmission using one or more available RBs within the one or more shared RB sets.

In a seventy-first aspect, in combination with the seventieth aspect, the identifying the one or more shared RB sets further includes detecting at least one PSFCH from at least one UE of the one or more neighboring UEs within the one or more shared RB sets.

In a seventy-second aspect, in combination with the seventy-first aspect, the COT-SI message further includes a third indication identifying a required shared bandwidth of the COT which is required to be occupied by any neighboring UE of the one or more neighboring UEs, the required shared bandwidth including one of: a specified set of RB sets of the plurality of RB sets, or the wideband operational frequency.

In a seventy-third aspect, in combination with the seventy-second aspect, transmitting a sidelink control information (SCI) message including a priority indicator identifying a priority of a corresponding PSSCH of the one or more PSSCH associated with the UE transmission of the corresponding PSSCH, and transmitting one or more physical sidelink shared channel (PSSCH) to at least one non-COT-initiating UEs of the one or more neighboring UEs.

In a seventy-fourth aspect, in combination with the seventieth aspect, electing to refrain from including the first indication in the COT-SI in response to a determination of no scheduled physical sidelink shared channel (PSSCH) being associated with the plurality of neighboring UEs within a plurality of PSSCH slots of the COT, and electing to include the first indication in the COT-SI in response to at least one of the scheduled PSSCH being associated with at least one neighboring UE of the plurality of neighboring UEs.

A seventy-fifth aspect includes a non-transitory computer-readable medium storing instructions on a UE. When executed by a processor, the instructions cause the processor to perform operations including receiving a COT-SI message from a COT-initiating UE, the COT-SI including a first indication enabling COT sharing of a COT having a wideband operational frequency associated with a plurality of RB sets and a second indication allowing transmission of PSFCHs, identifying at least one selected PSFCH of a plurality of selected PSFCHs for transmissions is within an RB of the plurality of RB sets and is associated with the COT-initiating UE, and transmitting, over an SL-U channel, one or more selected PSFCHs of the plurality of selected PSFCHs in at least one RB set of the plurality of RB sets.

In a seventy-sixth aspect, in combination with the seventy-fifth aspect, identifying one or more RB sets of the plurality of RB sets in which at least one non-COT-initiating-UE-addressed PSFCH of the plurality of selected PSFCHs is located and none of the at least one selected PSFCH of the plurality of selected PSFCHs is located; and repeating transmission of a COT-initiating-UE-addressed PSFCH of the at least one selected PSFCH associated with the COT-initiating UE in each of the one or more RB sets.

In a seventy-seventh aspect, in combination with the seventy-sixth aspect, identifying at least two COT-initiating-UE-addressed PSFCH of the at least one selected PSFCH associated with the COT-initiating UE, and selecting the COT-initiating-UE-addressed PSFCH from the at least two COT-initiating-UE-addressed PSFCH according to an associated priority of a physical sidelink shared channel (PSSCH) corresponding to each of the at least two COT-initiating-UE-addressed PSFCH, the associated priority of the PSSCH corresponding to the COT-initiating-UE-addressed PSFCH being one of: a highest priority PSSCH or a lowest priority PSSCH.

In a seventy-eighth aspect, in combination with one or more of the seventy-sixty aspect through the seventy-seventh aspect, identifying a plurality of scheduled PSFCHs over the plurality of RB sets including one or more COT-initiating-UE-addressed scheduled PSFCH corresponding to the at least one selected PSFCH associated with the COT-initiating UE and the COT-initiating-UE-addressed PSFCH in the each of the one or more RB sets, and selecting the plurality of selected PSFCHs from the plurality of scheduled PSFCH, a total number of the plurality of selected PSFCHs, N_{Tx,PSFCH}, being selected according to a number of scheduled PSFCHs, N_{sch,Tx,PSFCH}, in each RB set of the plurality of RB sets occupied by the one or more COT-initiating-UE-addressed scheduled PSFCH.

In a seventy-ninth aspect, in combination with one or more of the seventy-sixth aspect through the seventy-eighth aspect, identifying a plurality of scheduled PSFCHs for transmission in the COT, and selecting the plurality of selected PSFCHs to ensure at least one COT-initiating-UE-addressed PSFCH in each RB set of the plurality of RB sets occupied by a PSFCH transmission of the UE.

In a eightieth aspect, in combination with one or more of the seventy-fifth aspect through the seventy-ninth aspect, the COT-SI further includes a third indication identifying a required shared bandwidth of the COT which is required to be occupied by the UE upon sharing the COT, the required shared bandwidth including one or more required RB sets corresponding to one of: a pre-defined set of RB sets of the plurality of RB sets, or the wideband operational frequency.

In a eighty-first aspect, in combination with the eightieth aspect, receiving a sidelink control information (SCI) message from the COT-initiating UE including a priority indicator identifying a priority of a corresponding PSSCH of one or more PSSCH associated with the UE, the priority being related to the COT-initiating UE transmission of the corresponding PSSCH, identifying a highest priority between one or more PSFCH to be transmitted by the UE within the COT and one or more physical sidelink shared channel (PSSCH) to be transmitted by the UE within the COT, identifying that the COT can be partially shared, in response to the one or more PSFCH being identified as having the highest priority, and occupying the required shared bandwidth for PSFCH transmissions, in response to the one or more PSSCH having the highest priority.

In a eighty-second aspect, in combination with one or more of the eightieth aspect through the eighty-first aspect, selecting the plurality of selected PSFCHs for transmission from a plurality of scheduled PSFCHs to include at least one required PSFCH for transmission within each required RB set of the required shared bandwidth and at least one COT-initiating-UE-addressed PSFCH in at least one shared RB of the plurality of RB sets of the COT.

In a eighty-third aspect, in combination with eighty-second aspect, selecting a number of the plurality of selected PSFCHs, N_{Tx,PSFCH}, to be ≥X≥1, where

$$X = max ( {\sum }_{i = 1}^{K} {M}_{i} , Y ) ,$$

K being a largest value that a total transmission power of all X of the plurality of selected PSFCHs is no larger than P_{CMAX}, Mᵢ being a determined number of PSFCHs having a priority value, i, and Y being a PSFCH index of a specific PSFCH, each selected PSFCH of the plurality of selected PSFCHs is indexed in an ascending order priority rule, the selecting the number of the plurality of selected PSFCHs, N_{Tx,PSFCH}, being in response to the total transmission power of the plurality of selected PSFCHs, P_{Tx,PSFCH}, being greater than P_{CMAX}, the number of the plurality of selected PSFCHs, N_{Tx,PSFCH}, being less than or equal to a maximum number of simultaneous PSFCHs, N_{max,PSFCH}, and an initial power value for a downlink pathloss-based power control for PSFCHs, dl-P0-PSFCH, being configured at the UE.

In a eighty-fourth aspect, in combination with the eighty-third aspect, indexing each selected PSFCH of the plurality of selected PSFCHs according to one of: a time domain location, a frequency domain location, or a combination thereof of a physical sidelink shared channel (PSSCH) corresponding to the each selected PSFCH, the indexing each selected PSFCH of the plurality of selected PSFCHs being performed in response to two or more selected PSFCHs having a same priority under the ascending order priority rule.

In a eighty-fifth aspect, in combination with one or more of the eighty-third aspect through the eighty-fourth aspect, the specific PSFCH is identified as one of a first selected PSFCH of the plurality of selected PSFCHs that ensures the at least one required PSFCH is transmitted within the each required RB set of the one or more required RB sets, or the first selected PSFCH of the plurality of selected PSFCHs that ensures the at least one required PSFCH is transmitted within the each required RB set of the required shared bandwidth and the at least one COT-initiating-UE-addressed PSFCH is transmitted within the at least one shared RB of the plurality of RB sets of the COT.

In a eighty-sixth aspect, in combination with one or more of the eightieth aspect through the eighty-fifth aspect, selecting a number of the plurality of selected PSFCHs, N_{Tx,PSFCH}, to be ≥X≥1 up to a maximum number of simultaneous PSFCHs, N_{max,PSFCH}, where

$$X = max ( {\sum }_{i = 1}^{K} {M}_{i} Y ) ,$$

K being a largest value that a total transmission power of all X of the plurality of selected PSFCHs is no larger than P_{CMAX}, and Y being the PSFCH index of the specific PSFCH, and Y<the maximum number of simultaneous PSFCHs, N_{max,PSFCH}, otherwise

$$Y = {\sum }_{i = 1}^{K} {M}_{i} ,$$

the selecting the number of the plurality of selected PSFCHs, N_{Tx,PSFCH}, being performed in response to the number of the plurality of scheduled PSFCHs, N_{Tx,PSFCH}, exceeding the maximum number of simultaneous PSFCHs, N_{Tx,PSFCH}>N_{max,PSFCH}, and an initial power value for a downlink pathloss-based power control for PSFCHs, dl-P0-PSFCH, is configured at the UE.

In a eighty-seventh aspect, in combination with the eighty-sixth aspect, selecting the plurality of selected PSFCHs according to the ascending order priority rule, the plurality of selected PSFCHs being selected to be ≥Y′≥1, Y′ being the PSFCH index of the specific PSFCH, the selecting the plurality of the selected PSFCHs according to the ascending order priority rule being performed in response to the dl-P0-PSFCH not being configured at the UE.

In a eighty-eighth aspect, in combination with one or more of the eightieth aspect through the eighty-seventh aspect, selecting a number of the plurality of selected PSFCHs, N_{Tx,PSFCH}, PSFCHs according to a PSFCH selection sequence with N_{Tx,PSFCH}≥X≥1, with

$$X = max ( {\sum }_{i = 1}^{K} {M}_{i} , Y ) ,$$

the selecting the plurality of selected PSFCHs according to the PSFCH selection sequence being performed in response to a total transmission power of the plurality of scheduled PSFCHs, P_{sch,PSFCH}, being greater than a maximum transmission power, P_{CMAX}, the number of the plurality of scheduled PSFCHs, N_{sch,Tx,PSFCH}, being less than or equal to a maximum number of simultaneous PSFCHs, N_{max,PSFCH}, and an initial power value for a downlink pathloss-based power control for PSFCHs, dl-P0-PSFCH, being configured at the UE.

In a eighty-ninth aspect, in combination with the eighty-eighth aspect, the PSFCH selection sequence includes selecting a first set of selected PSFCHs, on a per RB basis of the one or more required RB sets, from the plurality of scheduled PSFCHs, each PSFCH of the first set of selected PSFCHs being associated with one of: a lowest priority according to an ascending order priority rule or an earliest slot, and selecting a next set of selected PSFCHs over remaining scheduled PSFCHs of the plurality of scheduled PSFCHs according to the ascending order priority rule for hybrid automatic repeat request—acknowledgement (HARQ-ACK)-information-containing PSFCHs of the remaining scheduled PSFCHs first and then conflict-information-containing PSFCHs of the remaining scheduled PSFCHs.

In a ninetieth aspect, in combination with one or more of the eighty-eighth through the eighty-ninth aspect, the PSFCH selection sequence includes selecting a first set of selected PSFCHs from one or more COT-initiating-UE-associated PSFCHs of the plurality of scheduled PSFCHs associated with one of: a lowest priority according to an ascending order priority rule or an earliest slot, selecting a second set of selected PSFCHs from remaining scheduled PSFCHs of the plurality of scheduled PSFCHs in one or more non-COT-initiating-UE-associated RB sets of the one or more required RB sets that have no PSFCH associated with the COT-initiating UE, each PSFCH of the second set of selected PSFCHs being associated with one of: a lowest priority according to the ascending order priority rule or an earliest slot, and selecting a third set of selected PSFCHs from the remaining scheduled PSFCHs of the plurality of scheduled PSFCHs according to the ascending order priority rule for hybrid automatic repeat request-acknowledgement (HARQ-ACK)-information-containing PSFCHs of the remaining scheduled PSFCHs first and then conflict-information-containing PSFCHs of the remaining scheduled PSFCHs.

In a ninety-first aspect, in combination with one or more of the eightieth aspect through the ninetieth aspect, selecting a number of the plurality of selected PSFCHs, N_{Tx,PSFCH}, from a maximum number of simultaneous PSFCHs, N_{max,PSFCH}, according to a PSFCH selection sequence in response to a number of scheduled PSFCHs, N_{sch,Tx,PSFCH}, being greater than the maximum number of simultaneous PSFCHs, N_{sch,Tx,PSFCH}>N_{max,PSFCH} and an initial power value for a downlink pathloss-based power control for PSFCHs, dl-P0-PSFCH, being configured, the PSFCH selection sequence including selecting the plurality of selected PSFCHs from the maximum number of simultaneous PSFCHs, N_{max,PSFCH}, according to one of the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCH, or to ensure at least one COT-initiating-UE-addressed PSFCH of the N_{Tx,PSFCH} PSFCHs is transmitted in each RB set of the plurality of RB sets occupied by a PSFCH transmission of the UE, where the number of the plurality of selected PSFCHs, N_{Tx,PSFCH}≥X≥1, and

$$X = max ( {\sum }_{i = 1}^{K} {M}_{i} ) ,$$

the selecting the plurality of selected PSFCHs according to one of: the ascending order priority rule of the plurality of scheduled PSFCHs or to ensure the at least one COT-initiating-UE-addressed PSFCH is transmitted in the each RB set occupied by the PSFCH transmission of the UE being performed in response to the total transmission power of the plurality of scheduled PSFCHs, P_{sch,Tx,PSFCH}, being greater than a maximum transmission power, P_{CMAX}, the number of the plurality of scheduled PSFCHs, N_{sch,Tx,PSFCH}, being less than or equal to the maximum number of simultaneous PSFCHs, N_{max,PSFCH}, and the dl-P0-PSFCH being configured at the UE.

In a ninety-second aspect, in combination with one or more of the eightieth aspect through the ninety-first aspect, selecting the plurality of selected PSFCHs from the maximum number of simultaneous PSFCHs, N_{max,PSFCH}, according to one of the ascending order priority rule of the plurality of scheduled PSFCHs up to a number of the plurality of selected PSFCHs, N_{Tx,PSFCH}, being determined according to the number of scheduled PSFCHs, N_{sch,Tx,PSFCH}, in each RB set of the plurality of RB sets occupied by one or more COT-initiating-UE-addressed scheduled PSFCH, or to ensure at least one COT-initiating-UE-addressed PSFCH of the N_{Tx,PSFCH} PSFCHs is transmitted in each RB set of the plurality of RB sets occupied by a PSFCH transmission of the UE, where the number of the plurality of selected PSFCHs, N_{Tx,PSFCH}≥X≥1, and

$$X = max ( {\sum }_{i = 1}^{K} {M}_{i} )$$

and a total transmission power of the plurality of selected PSFCHs, P_{Tx,PSFCH}, is less than or equal to a maximum transmission power, P_{CMAX}, the selecting the plurality of selected PSFCHs according to one of: the ascending order priority rule of the plurality of scheduled PSFCHs or to ensure the at least one COT-initiating-UE-addressed PSFCH being transmitted in each RB set occupied by the PSFCH transmission of the UE being performed in response to a downlink pathloss-based power control for PSFCHs, dl-P0-PSFCH, not being configured at the UE.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus for wireless communication at a user equipment (UE) comprising:
at least one memory; and
at least one processor coupled with the at least one memory, the at least one processor operable to cause the UE to:
establish a channel occupancy time (COT) having a wideband operational frequency associated with a plurality of resource block (RB) sets;
transmit over an unlicensed sidelink (SL-U) channel a COT structure information (COT-SI) message that includes a first indication enabling COT sharing with one or more neighboring UEs capable of SL-U communication and a second indication allowing transmission of physical sidelink feedback channels (PSFCHs);
complete a first transmission within a portion of the COT;
identify a second transmission to renew transmissions within the COT;
identify one or more shared RB sets from the plurality of RB sets; and
transmit the second transmission using one or more available RBs within the one or more shared RB sets.

2. The apparatus of claim 1, wherein the at least one processor operable to cause the UE to identify the one or more shared RB sets is further operable to cause the UE to detect at least one PSFCH from at least one UE of the one or more neighboring UEs within the one or more shared RB sets.

3. The apparatus of claim 1, wherein the COT-SI message further includes:
a third indication identifying a required shared bandwidth of the COT which is required to be occupied by any neighboring UE of the one or more neighboring UEs, the required shared bandwidth including one of: a specified set of RB sets of the plurality of RB sets, or the wideband operational frequency.

4. The apparatus of claim 3, further including the at least one processor operable to cause the UE to:
transmit a sidelink control information (SCI) message including a priority indicator identifying a priority of a corresponding PSSCH of the one or more PSSCH associated with the UE transmission of the corresponding PSSCH; and
transmit one or more physical sidelink shared channel (PSSCH) to at least one non-COT-initiating UEs of the one or more neighboring UEs.

5. The apparatus of claim 1, further including the at least one processor operable to cause the UE to:
elect to refrain from including the first indication in the COT-SI in response to a determination of no scheduled physical sidelink shared channel (PSSCH) being associated with the plurality of neighboring UEs within a plurality of PSSCH slots of the COT; and
elect to include the first indication in the COT-SI in response to at least one of the scheduled PSSCH being associated with at least one neighboring UE of the plurality of neighboring UEs.

6. An apparatus for wireless communication at a user equipment (UE) comprising:
at least one memory; and
at least one processor coupled with the at least one memory, the at least one processor operable to cause the UE to:
receive a channel occupancy time-structure information (COT-SI) message from a COT-initiating UE, the COT-SI including a first indication enabling COT sharing of a COT having a wideband operational frequency associated with a plurality of resource block (RB) sets and a second indication allowing transmission of physical sidelink feedback channels (PSFCHs);
identify at least one selected PSFCH of a plurality of selected PSFCHs for transmissions is within an RB of the plurality of RB sets and is associated with the COT-initiating UE; and
transmit, over an unlicensed sidelink (SL-U) channel, one or more selected PSFCHs of the plurality of selected PSFCHs in at least one RB set of the plurality of RB sets.

7. The apparatus of claim 6, further including the at least one processor operable to cause the UE to:
identify one or more RB sets of the plurality of RB sets in which at least one non-COT-initiating-UE-addressed PSFCH of the plurality of selected PSFCHs is located and none of the at least one selected PSFCH of the plurality of selected PSFCHs is located; and
repeat transmission of a COT-initiating-UE-addressed PSFCH of the at least one selected PSFCH associated with the COT-initiating UE in each of the one or more RB sets.

8. The apparatus of claim 7, further including the at least one processor operable to cause the UE to:
identify at least two COT-initiating-UE-addressed PSFCH of the at least one selected PSFCH associated with the COT-initiating UE; and
select the COT-initiating-UE-addressed PSFCH from the at least two COT-initiating-UE-addressed PSFCH according to an associated priority of a physical sidelink shared channel (PSSCH) corresponding to each of the at least two COT-initiating-UE-addressed PSFCH, the associated priority of the PSSCH corresponding to the COT-initiating-UE-addressed PSFCH being one of: a highest priority PSSCH or a lowest priority PSSCH.

9. The apparatus of claim 7, further including the at least one processor operable to cause the UE to:
identify a plurality of scheduled PSFCHs over the plurality of RB sets including one or more COT-initiating-UE-addressed scheduled PSFCH corresponding to the at least one selected PSFCH associated with the COT-initiating UE and the COT-initiating-UE-addressed PSFCH in the each of the one or more RB sets; and
select the plurality of selected PSFCHs from the plurality of scheduled PSFCH, a total number of the plurality of selected PSFCHs, N_{Tx,PSFCH}, being selected according to a number of scheduled PSFCHs, N_{sch,Tx,PSFCH}, in each RB set of the plurality of RB sets occupied by the one or more COT-initiating-UE-addressed scheduled PSFCH.

10. The apparatus of claim 7, further including the at least one processor operable to cause the UE to:
identify a plurality of scheduled PSFCHs for transmission in the COT; and
select the plurality of selected PSFCHs to ensure at least one COT-initiating-UE-addressed PSFCH in each RB set of the plurality of RB sets occupied by a PSFCH transmission of the UE.

11. The apparatus of claim 6, wherein the COT-SI further includes a third indication identifying a required shared bandwidth of the COT which is required to be occupied by the UE upon sharing the COT, the required shared bandwidth including one or more required RB sets corresponding to one of: a pre-defined set of RB sets of the plurality of RB sets, or the wideband operational frequency.

12. The apparatus of claim 11 further including the at least one processor operable to cause the UE to:
receive a sidelink control information (SCI) message from the COT-initiating UE including a priority indicator identifying a priority of a corresponding PSSCH of one or more PSSCH associated with the UE, the priority being related to the COT-initiating UE transmission of the corresponding PSSCH;
identify a highest priority between one or more PSFCH to be transmitted by the UE within the COT and one or more physical sidelink shared channel (PSSCH) to be transmitted by the UE within the COT;
identify that the COT can be partially shared, in response to the one or more PSFCH being identified as having the highest priority; and
occupy the required shared bandwidth for PSFCH transmissions, in response to the one or more PSSCH having the highest priority.

13. The apparatus of claim 11, further including the at least one processor operable to cause the UE to:
select the plurality of selected PSFCHs for transmission from a plurality of scheduled PSFCHs to include at least one required PSFCH for transmission within each required RB set of the required shared bandwidth and at least one COT-initiating-UE-addressed PSFCH in at least one shared RB of the plurality of RB sets of the COT.

14-23. (canceled)

24. A method of wireless communication performed by a user equipment (UE), the method comprising:
establishing a channel occupancy time (COT) having a wideband operational frequency associated with a plurality of resource block (RB) sets;
transmitting over an unlicensed sidelink (SL-U) channel a COT structure information (COT-SI) message that includes a first indication enabling COT sharing with one or more neighboring UEs capable of SL-U communication and a second indication allowing transmission of physical sidelink feedback channels (PSFCHs);
completing a first transmission within a portion of the COT;
identifying a second transmission to renew transmissions within the COT;
identifying one or more shared RB sets from the plurality of RB sets; and
transmitting the second transmission using one or more available RBs within the one or more shared RB sets.

25. The method of claim 24, wherein the identifying the one or more shared RB sets from the plurality of RB sets includes detecting at least one PSFCH from at least one UE of the one or more neighboring UEs within the one or more shared RB sets.

26. The method of claim 24, wherein the COT-SI message further includes:
a third indication identifying a required shared bandwidth of the COT which is required to be occupied by any neighboring UE of the one or more neighboring UEs, the required shared bandwidth including one of: a specified set of RB sets of the plurality of RB sets, or the wideband operational frequency.

27. A method of wireless communication performed by a user equipment (UE), the method comprising:
receiving a channel occupancy time-structure information (COT-SI) message from a COT-initiating UE, the COT-SI including a first indication enabling COT sharing of a COT having a wideband operational frequency associated with a plurality of resource block (RB) sets and a second indication allowing transmission of physical sidelink feedback channels (PSFCHs);
identifying at least one selected PSFCH of a plurality of selected PSFCHs for transmissions is within an RB of the plurality of RB sets and is associated with the COT-initiating UE; and
transmitting, over a SL-U channel, one or more selected PSFCHs of the plurality of selected PSFCHs in at least one RB set of the plurality of RB sets.

28. The method of claim 27, further including:
identifying one or more RB sets of the plurality of RB sets in which at least one non-COT-initiating-UE-addressed PSFCH of the plurality of selected PSFCHs is located and none of the at least one selected PSFCH of the plurality of selected PSFCHs is located; and
repeating transmission of a COT-initiating-UE-addressed PSFCH of the at least one selected PSFCH associated with the COT-initiating UE in each of the one or more RB sets.

29. The method of claim 28, further including one of:
identifying a plurality of scheduled PSFCHs over the plurality of RB sets including one or more COT-initiating-UE-addressed scheduled PSFCH corresponding to the at least one selected PSFCH associated with the COT-initiating UE and the COT-initiating-UE-addressed PSFCH in each of the one or more RB sets; and selecting the plurality of selected PSFCHs from the plurality of scheduled PSFCH, a total number of the plurality of selected PSFCHs, N_{Tx,PSFCH}, being determined according to a number of scheduled PSFCHs, N_{sch,Tx,PSFCH}, in each RB set of the plurality of RB sets occupied by the one or more COT-initiating-UE-addressed scheduled PSFCH; or
identifying a plurality of scheduled PSFCHs for transmission in the COT; and selecting the plurality of selected PSFCHs to ensure at least one COT-initiating-UE-addressed PSFCH in each RB set of the plurality of RB sets occupied by a PSFCH transmission of the UE.

30. The method of claim 27, wherein the COT-SI further includes a third indication identifying a required shared bandwidth of the COT which is required to be occupied by the UE upon sharing the COT, the required shared bandwidth includes one or more required RB sets corresponding to one of: a pre-defined set of RB sets of the plurality of RB sets, or the wideband operational frequency.

31-40. (canceled)
